(19) United States
(12) Patent Application Publication
(10) Pub. No.: US 2001/0046262 A1
(43) Pub. Date: Nov. 29, 2001

(54) System and method for transmitting a broadcast television signal over broadband digital transmission channels

(76) Inventor: Robert M. Freda, New York, NY (US)

Correspondence Address: William L. Muckelroy, Esq., P.C., Ewing Professional Building, 1901 N. Olden Avenue, Suite 3A, Trenton, NJ, 08618, US

(21) Appl. No.: 09/797,999

(22) Filed: Mar. 3, 2001

Related U.S. Application Data
(60) Provisional application No. 60/188,215, filed on Mar. 10, 2000.

(51) Int. Cl. H04N 7/12

(52) U.S. Cl. 375/240.03; 375/240.02

(57) ABSTRACT

A system and method for encoding and decoding an input video signal representative of an original moving or still image. The system includes a subsystem for low-bit rate encoding, transmission, and decoding of the moving or still image, and a server/client based buffering subsystem for receiving and decoding the encoded transmission. The client/server based buffering subsystem uses pre-cached and pre-determined content to counteract channel data overflow and create seamless viewing of the moving or still image. The encoding-decoding subsystem processes the input video signal into a format suitable for transmission and subsequent decoding be deconstructing and quantizing the signal into a waveform representing its component elementary parts according to a pre-determined luminance/chrominance gradient field or matrix of defined amplitude. The waveform is generated according to an optimally structured base code within the luminance/chrominance gradient matrix field as defined by minimum sampling rates. The waveform accurately describes the original moving or still image, within an acceptable visible variation as compared to an acceptable bit-rate for the capacity of a given transmission channel. The base code is compressed by a lossless data compression method that is dependent on transmission channel capacity limitations and/or resultant code size. The compressed command code can be transmitted to either a storage facility or to a client. If transmitted to a client, the code is decompressed into the original base code and then decoded by client-side software or hardware to reconstruct the original image within the pre-determined luminance/chrominance gradient field matrix and a pre-defined or sent coding table. The reconstructed original moving or still image can then be displayed on a video display device. Systematic use of the system and method offers a seamless viewing experience on the client side even if the size of the transmitted code exceeds the transmission channel capacity.

### PRIORITY DATE

The applicant claims a priority date of Mar. 10, 2000 based on the filing of a provisional application by the applicant having a Ser. No. 60/188,215 on Mar. 10, 2000.

### BACKGROUND OF THE INVENTION

1. Field of the Invention

The invention relates to encoding and decoding video image signals in general. In particular, the invention relates to apparatus and methods for encoding and decoding video image signals, either digital or analog, stored or live, using partitive or non-partitive image formation and pre-defined gradient fields or matrices with alternative methods of pixel description within the fields and matrices.

2. Description of the Related Art

The development of digital data compression techniques for compressing visual information is very significant due to the growing demand for higher transmission capability and lower bit codes and the concomitant ability to stream video or still images through a limited capacity channel.

This growing demand includes the desire for improved next generation television transmission quality, including high definition television (HDTV), video conferencing, digital broadcasting, digital storage and recording, multimedia PC, gaming, and video telephony over the Internet, across intranets, and through extranets.

Digital channel capacity is the most important parameter in digital signal transmission because insufficient channel capacity limits the amount of data that is transmittable in a given time frame. Because of this, the digital transmission process requires very efficient source encoding to overcome channel limitations. A major technical problem in video source encoding is usually the tradeoff between the amount of compression that is required for a given channel capacity and image quality or frame rate. Data overflow is another major problem as the bit code exceeds the capacity of the given channel. Yet another problem is the speed of image decompression maintaining pace with playback. This usually relates directly to the computational complexity of the encoder/decoder solution. Also of concern is the technical problem of the variable nature of the compressed code from image to image that creates channel management problems from scene to scene within the same transmission.

Almost all the video source encoding techniques achieve compression by exploiting both the spatial and temporal redundancies inherent in the visual source signals either on a frame by frame basis or in a series of frames. The bit code resulting from these types of compression is highly variable depending on the amount of motion within a series of frames or the image complexity within a single image.

For example, U.S. Pat. No. 5,444,489 to Troung et al. discusses vector quantization video encoding using a hierarchical cache memory scheme. They state that the common objective of all source encoding techniques is to reduce the bit rate of some underlying source signal for more efficient transmission and/or storage. The source signals of interest are usually in digital form. Examples of these are digitized speech samples, image pixels, and a sequence of images. Source encoding techniques can be classified as either lossless or lossy. In lossless encoding techniques, the reconstructed signal is an exact replica of the original signal, whereas in lossy encoding techniques, some tolerable distortion is introduced into the reconstructed signal.

Consider U.S. Pat. No. 5,377,329 to Seitz which discusses an apparatus and method for reducing the transmission of data on a data communication network, thereby increasing the apparent transfer rate, by obtaining data from a cache rather than by transmitting the data. The method calls for maintaining an indexed cache of data from previous transmissions, and replacing duplicate information by a flag and an index to the cached data whenever duplicate information is to be transmitted.

U.S. Pat. No. 5,892,915 to Duso et al. discusses a system and method for providing broadcast video playback functionality, involving a video file server, a data network, a client, and a continuous media server in the data network. The file server includes stream servers, one or more control servers and a cached disk array storage subsystem. The system provides for transmission of continuous video data from the server to a destination in the network.

Also, U.S. Pat. Nos. 5,805,228 and 5,864,681, both to Proctor et al., discuss a method and apparatus for encoding and decoding an image signal involving an acquisition module disposed to receive the image signal, a plurality of processors and an ordinary modem. Their method includes converting the image signal into a predetermined digital format and transferring the format to an encoding processor. A hierarchical vector quantization compression algorithm is applied to the digitized image signal, and a resultant encoded bit stream generated by the algorithm is collected. According to the Proctor et al method, the range of possible input values is partitioned into a finite collection of sub-ranges, and then, for each sub-range, a representative value is selected to be output when an input value is within the sub-range. Further, they use vector quantization (VQ), which allows the same two operations to take place in a multi-dimensional vector space. The modem is used to transmit and receive the resultantly processed digitized image signal over a narrow-band telephone line. Unfortunately, the Proctor et al. system and method suffers from the disadvantage of requiring significant level of computational power to perform the vector quantization of rapidly moving images, which would also tend to reduce the required bandwidth for transmission, but such methods are effective only within the limitations of vector codebooks.

By way of background, vector quantization (VQ) was introduced in the late 1970's as a technique to encode source vectors. Vector space is partitioned into sub-ranges each having a corresponding representative value or code vector.

An advantage of the VQ approach is that it can be combined with many hybrid and adaptive schemes to improve the overall encoding performance, and generally achieve high compression. The receiver structure of VQ consists of a statistically generated codebook containing code vectors, also known as reconstruction vectors, for each quantizer. Each code vector, or reconstruction vector, is represented by a single index for transmission, and quantization is performed by comparing each multidimensional input signal (such as each of the red-green-blue components) with each of the chosen code vectors or reconstruction vectors, and then choosing the vector that represents the smallest error.

The current state of the art in vector quantization encoders can achieve, in combination with wavelet algorithms, lossy bit rates as low as 0.25 bits per pixel. While this is impressive compression, it is far from the bit rates needed to stream full screen/full rate broadcast video over low to mid bit rate channels, such as telephone lines. Storage capacity is also an important issue with regard to image data. To stream video over low bit rate channels and reduce necessary storage capacity, a desirable encoded bit rate would be less than 0.1 bits per pixel (sub-impps).

More in depth discussions of the basic principles of vector quantization are presented in the following publications: A. Gersho in “Asymptotically Optimal Block Quantization,” IEEE Trans. Information Theory, vol. 25, pp. 373-380, July 1979; Y. Linde, A. Buzo, and R. Gray, “An algorithm for vector quantization design,” IEEE Trans. Commun., vol. 28, pp. 84-95, January, 1980; and R. M. Gray, J. C. Kieffer, and Y. Linde, “Locally Optimal Quantizer Design,” Information and Control, vol. 45, pp. 178-198, 1980.

Vector quantization is but one of two common quantization techniques; the other common quantization technique is known as scalar quantization. Scalar quantization is further divided into uniform scalar quantization and non-uniform scalar quantization. Both uniform scalar quantization and non-uniform scalar quantization seek to control the precision of expression of a single, one-dimensional parameter, such as intensity, while the vector quantization technique seeks to approximate two or more parameters by a single value. For example, with respect to the RGB (red-green-blue) coordinates of a color video image, scalar quantization would operate on only one of red, green or blue, while vector quantization would operate in a multi-dimensional manner to create a value represented by more than one coordinate.

Thus, vector quantization is clearly useful alone as a more powerful compression technique, although it is more complicated to implement than scalar quantization techniques. Uniform scalar quantization is by far the simplest quantization technique and is often analogized to a set of stairs having equal spacing between the steps. An input signal subjected to uniform scalar quantization is constrained to only the values represented by the equal spacing between the steps. Thus, a continuum of input values is divided into a number of ranges of equal value. The greater the interval between the steps, the more coarse the quantization value will be, or similarly, the smaller the interval between the steps, the more fine the quantization value will be. As the input values are processed by the quantization, they are compared with pre-defined decision values representing the steps. Any input value between any two decision values will be assigned to a corresponding output symbol. A reconstruction value is used to produce an approximation of the original range of input values. On the other hand, non-uniform scalar quantization of an input signal follows the same overall procedure as the uniform quantization technique, but is often analogized to a set of stairs having unequal spacing between the steps.

### SUMMARY OF THE INVENTION

The inventor has recognized that most vector and scalar quantization techniques have the same essential failing with regard to image compression and especially with regard to transmission of compressed images, in that they begin not from the visual basis and structure of the information they are attempting to reduce and reconstruct, but from the totality of the information needed to describe a given image or series of images in a specific digital format. These methods take all the information of a digitized image or scene and perform mathematical transforms usually through some type of block-based scalar or vector quantization based upon a 16 bit, 24 bit or 32 bit source data of a frame or series of frames. From a limited-channel transmission or storage perspective, this is a highly ineffective approach as it is based on a premise which accommodates mathematical structure rather than visual structures. Highly variable rates of quality, computational complexity, frame rate playback, and frame or scene code size, all of which taken in combination or individually lead to data overflow, image degradation (blocking in the most common schemes), or decompression asynchronization and ultimately to a detractive experience on the client side.

The inventor has recognized that what is needed for efficient digital motion image transmission is a method by which a stable maximum frame bit size and consistent quality can be maintained while radically reducing the size of the bit code needed to describe the image or series of images for reconstruction and display after transmission or storage. In such a scheme the final method of display can be considered as a separate and non-essential issue with regard to the construction of the transmitter code. Thus, the inventor has discovered that an additional feature in an efficient encoding scheme would be for the encoded image, once reduced to a base instruction code, to have no natural size. Thus, one object of the novel invention is would be for that base instruction code to be susceptible to further compression. This is an essential object of this invention.

There are methods for reducing an image to the basic visual elements needed to represent the original image. These methods are in use in analog visual systems. The inventor applied them to digital image transmission.

### OBJECTS OF THE INVENTION

Therefore, it is an object of this invention to set forth apparatus and methods for encoding and decoding video image signals using partitive or non-partitive image formation and pre-defined gradient fields or matrices with alternative methods of pixel description within the fields and matrices.

It is also an object of this invention to set forth apparatus and methods for managing a given channel as a constant data-stream at any given moment regardless of user interaction.

It is another object of this invention to set forth coding methods by which images can be described and source-coded more efficiently for digital transmission over limited capacity channels.

It is a further object of this invention to set forth ways in which the base/source or instruction code derived by these methods can be compressed at the point of source-coding and concurrently structured to be further reduced by a combination of data compression methods.

It is an additional object of this invention to set forth a system that can function over limited capacity channels using interframe compression and/or intraframe and interstitial compression or a combination thereof

It is another object of this invention to set forth a system that can accurately transmit and receive video data via transmission channel based upon the computational complexity processing supported by the receiver.

It is yet another object of this invention to create a weighted system whereby the mathematical complexity of the method is significantly more complex in the encoding than in the decoding.

It is yet a further object of this invention to detail methods for source coding audio and video signals.

It is still a further aspect of the invention to provide a system and method that can accurately transmit and receive digital data over a limited bandwidth communication channel using non-artifacting or “lossless” compression techniques.

These and other features, aspects and advantages of the present invention will become better understood with regard to the following description, appended claims and accompanying drawings.

### BRIEF DESCRIPTION OF THE DRAWINGS

The present invention can be better understood with reference to the following drawing figures, wherein:

FIG. 1 shows a general flow diagram according to the present invention;

FIG. 2 shows an object and proximity block arrangement according to the present invention;

FIG. 3 shows similarities between proximate linear samples according to the present invention;

FIG. 4 shows component blocks according to the present invention;

FIG. 5 shows proximity blocks according to the present invention;

FIG. 6 shows separation of code into various components according to the present invention;

FIG. 7 shows a fixed length prefix variable length codebook according to the present invention;

FIG. 8 shows a scene block according to the present invention;

FIG. 9 shows a delay block according to the present invention;

FIG. 11 shows partitive channel input processor structure according to the present invention;

FIG. 10 shows error control for the compressed code according to the present invention; and

FIGS. 12 and 13 show retrieval of interstitial data in a digitized image according to the present novel invention.

### DETAILED DESCRIPTION OF THE INVENTION

Current methods of image compression, such as discrete cosine transform (DCT), vector quantization (VQ), the Joint Photographic Expert's Group (JPEG), Motion Pictures Experts Group (MPEG, MPEG-1, MPEG-2), etc., are essentially inefficient for image transmission over a narrow bandwidth communication channel, such as a telephone line, and are especially inefficient for transmission of a series of images in motion, both in terms of data overflow, quality, scalability, and computational complexity.

This is true not necessarily in terms of the actual compression that the transformators yield on a given string of binary image data, but in that the source data they compress is unnecessarily cumbersome with regard to transmission.

Moreover, due to the realities of a heavily-used limited capacity channel in terms of fluctuating or low downstream bit rates, which is undesirable for commercial viability of a digital broadcast system, a superior compression scheme must make efficient use of the entire channel capacity. Thus, ‘channel maximization’ according to the present invention, can ensure a seamless viewing experience on the client side by counteracting data overflow.

These types of compression fall into two distinct categories: (1) base compression performed simultaneous to the source coding, and (2) data compression performed on the resultant source code.

Almost all analog techniques for representing a photographic still or moving image for display rest at some level on partitive image formation, as previously mentioned RGB in a linear or dot display. Partitive image formation can be used in the digital environment to revert 16 bit, 24 bit or 32 bit, or analog images to a more manageable and reducible three, four, or six color partitive digital formats. Once a digital image is treated in a partitive state the possibilities for describing that image in an acceptable format for transmission both from a bit size and quality perspective increase dramatically. Conversely an image which has been reduced and transmitted in a partitive digital format can, dependent of the processing power available on the client side, be reconstructed and displayed either in that partitive digital format or in any digital format.

The possibilities opened by partitive formation in the digital environment also open the way for distinctly different, non-16 to 32 bit source code based methods of describing the visual information of a given image or series of images in comparatively small bit code instruction sets which can then be subjected to lossless compression coding methods (such as Huffman, Arithmetic, LZW, etc.) to further reduce the code for transmission.

Therefore, the methods of the present invention are based upon the partitive formation or non-partitive formation of an image or series of images which allow certain types of image data reduction and reintroduction both within the image and over a series of frames that are proscribed by the transform or vector compression methods.

Additionally, the present invention defines a method by which a transmission channel can be managed to offer a seamless viewing experience of the video images even if the size of the transmitted code exceeds the transmission channel capacity.

Of the three coding methods discussed herein, two are based on partitive digital image description and one is based on a non-partitive digital image description.

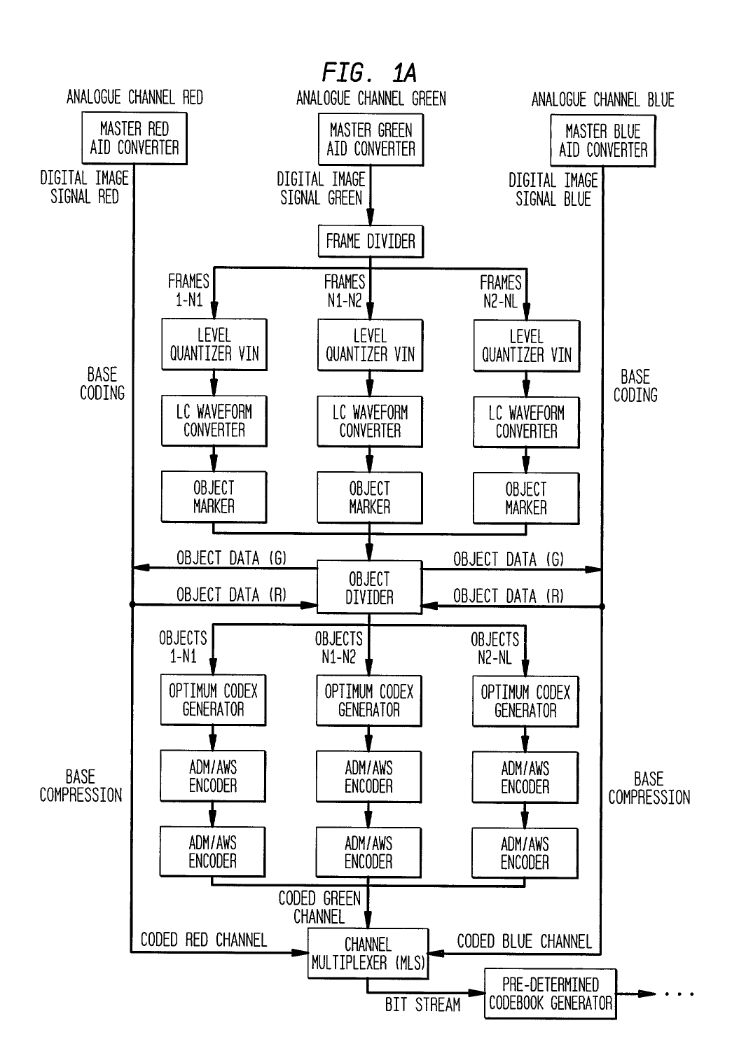

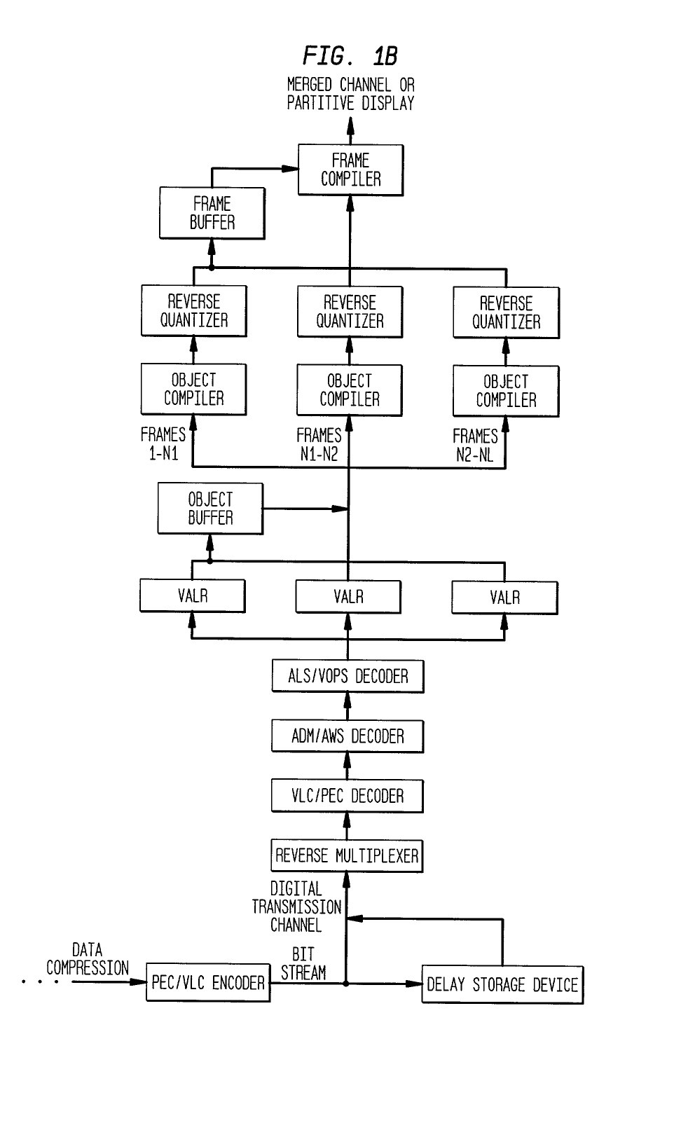

FIG. 1 shows a flow diagram of a merged or partitive display 500 according to the present invention.

A partitive image format is any visual system that constructs an image out of a limited number of component colors one each appearing on the three primary analogue channels, namely red 100, green 200 and blue 300. These analog channel colors 100, 200, 300 can be any set of colors that when placed in close proximity and displayed at sufficiently small size can through variation in their respective luminance/chrominance values produce the appearance of the full range of the visible color spectrum. The most common and simplest varieties of these systems in analog use today are the three and four color systems, RGB, CMKY, RGBY. The partitive image format differs from existing digital image codices in that it does not attempt to actually describe the full or partial chromatic range of visible light as do 16 bit, 24 bit and 32 bit systems, but instead only produces the perception of that full spectrum.

The advantage of coding based on a digital partitive system, regardless of the method of final display, is a reduction in the amount of bit code needed to transmit the information necessary to reconstruct a given image on the client side. Thus, digital partitive encoding systems provide more efficient source or base coding and thereby significantly lower bit-rates required for transmission over limited capacity channels. Moreover, similar to the 16 bit to 32 bit codices, these partitive source codes are susceptible to further data compression before transmission.

Although the partitive system according to the present invention converts the digital image transmission codices mentioned above, are RGB and RIM, B/C and G/Y, any number of component color formats could be substituted and coded. Also, hybrid systems can be used by combining elements of both methods, to create for example an RGBY or four-color component color format. In partitive image formation the component colors 100, 200, 300 and their various luminance/chrominance values are easily assigned numeric values (in normal RGB the value of white is R:255, B:255, G:255).

In the digital partitive system of the present invention, these numerical values can be quantized into a set number of luminance/chrominance levels by the formula value difference between quantized levels = total number of luminance/chrominance variations/desired # of quantized levels (for example: 8=255/32) that can be lowered or raised dependent on the channel bit-rate capacity, desired quality, and the types of base and data compression that can be applied at a given client side processing capacity. In addition, on the client side, the partitive image data, once transmitted and received, can be displayed in either the full spectrum formats, by use of a merged channel display, or directly in the partitive format in which the data was transmitted.

The present invention also considers a non-partitive digital image format as an alternative method of encoding the visual information of a given image in the full visible color spectrum much like 16, 24 and 32 bit systems, but based not on direct but differential description, similar to but more complex than the coding scheme used for the six color partitive digital image format.

Once a given image or series of images has been digitized, converted into a desired partitive format, and quantized to a suitable number of N luminance/chrominance levels for a given channel capacity, the given image or series of images are ready for the source/base coding method to be applied to the visual data contained therein.

According to the method of the present invention, the entire image is quantized prior to source coding rather than the thresholding being applied to source code block formations as is the case in discrete cosine transform (DCT), scalar quantization and in some cases vector quantization (VQ) compressions. The resulting digital encoded value is hereinafter referred to as the waveform image description.

For the RGB waveform partitive digital image description discussed above, quantized levels of a particular color channel (i.e. 255:0:0, 255:8:8, 255:n+8:n+8, 255+−8:0:0, quantization based on a 256 variation color description quantized at 32 levels) can be regarded for the purposes of coding as forming a ‘luminance/chrominance gradient field’ or L/C field of a defined amplitude and comprised of discrete values (in the above case 32) in which a single horizontal or vertical line of visual information of the dimensions 1× Npi in any one of the partitive component colors, red, green, or blue, can be mapped as a waveform.

Once a given line of partitive visual information has been mapped as a waveform within an L/C field, the information contained therein is susceptible to the general types of coding that are applicable to other waveforms. More particularly that visual data can be source-coded by methods similar to those applied to digitizing sound waves wherein the amplitude of the L/C field is comparable to the amplitude of a given sound wave and the length of a given line is comparable to time. Furthermore, due to their nature, these waveforms can be encoded by methods that yield smaller source codes than typical sound wave transform-based coding methods.

The waveform method takes advantage of the L/C waveform and the repetitive nature of the visual information contained therein by utilizing a method that samples the waveform asynchronously, wherein the sampling intervals are determined by actual changes in the L/C values of a given L/C waveform coded with an asynchronous or weighted sampling description set (i.e. sampling bit code = next interval at N, N+1, N+3, N+6, etc.). This sampling method has been termed asynchronous waveform sampling or (AWS) and provides, in the case of the L/C waveform, a far more accurate description of the waveform than current synchronous sampling methods. However, in the case of the six or hybrid partitive digital image description method, there is an additional code to indicate a chromatic change within the partitive linear sample, i.e. green to yellow.

The present invention also allows for shorter bit codes to be used to describe L/C value changes within L/C fields of wider amplitudes than are possible in typical differential modulation schemes. This method has been termed asynchronous differential modulation (ADM). ADM comprises two coding components: namely, 1) a directional component and 2) a differential component. This method diverges from normal or synchronous differential modulation methods, such as DPCM or delta modulation, in that it involves the creation of a non-predictive coding table for the differential component that describes the value changes within the L/C field by means of an asynchronous or weighted differential description set (i.e. differential bit code a, b, c, etc. = level shift within L/C field of N, N+1, N+3, N+6, etc.).

Taken in combination these two coding techniques constitute a waveform source coding method that capitalizes on the random nature and spatial redundancies of visual data, yielding source codes on quantized images that are generally considerably smaller than 1 bit per pixel and are susceptible to further base and data compression.

Additionally, asynchronous differential modulation/asynchronous waveform sampling (ADM/AWS) codes can be encoded as ADM/AWS vectors with error correction instead of scalars if in a particular implementation it was indicated to be of benefit with regard to precision and encoded bit rates. Furthermore, encoding ADM/AWS intervals as vectors instead of scalars opens the way to the use of vector trellis or lattice structures.

A number of methods can be used in determining an optimal ADM/AWS set of differential values, dependent on the desired computational complexity of a given solution. The mathematical techniques that are applicable to ADM/AWS are generally known in the art as numerical methods for solving differential equations wherein the equation is solved for an optimal set of variable step-size values for h as limited by the respective n bit AWS and ADM sub-codes in the coding table and the numeric values for y are known on a 1 to 1 sampling basis. A number of solutions based on one-step Runge-Kutta methods or multi-step methods are applicable in the present invention given the level of acceptable encoding error at a particular original resolution or coding detail.

The waveform method also has some very desirable characteristics beyond the source code reduction it achieves. The first is that as a waveform the visual data once encoded has no natural size and can be subjected to a process herein referred to as a Inverse Quantization on the client side. Once the waveform of a given line of red, green, or blue has been mapped, sent, received, and decoded it can be scaled both in terms of pixel length and in terms of L/C field amplitude to whatever display resolution and color depth is desired. Also, as will be described later in the invention, interstitial waveforms can be constituted or reconstituted by analyzing the characteristics of two parent or sample waveforms. In essence this means that any image encoded by the AWS/ADM method has no natural size within the parameters of the original coding detail.

The second benefit is that the AWS/ADM encoding method itself and a variety of common algorithms, such as the Bezier algorithm, that can be applied on the client side to smooth the L/C waveforms have the combinative effect of equalizing or counteracting any blocking or radical luminance shifts that occur from quantization. In some cases this gives an encoded and then decoded image a ‘cleaner look’ than even the original. Generally speaking it eliminates the visual ‘noise’ normally associated with compression and transmission.

The third advantage is that, in cases of extremely low bit rate channels, a minimum asynchronous sampling rate can be set to further reduce code size. This limit can either be applied universally to the image or as preferred in this invention selectively to eliminate elements of a given image that are deemed unnecessary, such as minor background “objects” in the object marking method detailed in this invention. Also the coding method can be structured to code certain types of visual noise to be generated on the client side by component elements of the decoded L/C waveforms, a very useful feature for images that have repetitively complex or ‘noisy’ backgrounds.

Another advantage of the AWS/ADM method is the ease with which objects can be marked and tracked since any variance within the L/C field as described by a single pulse of the L/C waveform indicates the presence of an object. The object's boundary is defined by a comparison of that variation spatially across proximate waveforms and temporally across a series of frames.

Additionally, in the ADM coding scheme there are usually two ‘free’ or unused binary codes (differential shifts equaling zero or the full amplitude of the L/C field are unidirectional leaving two duplicate codes in the code set) that can be used in combination with the object code sets to mark a variety of object types and boundaries [(2(2ΛN)) where N is the number of bits in a particular object code table].

Therefore, if a particular combination of channel capacity and computational complexity indicated that interframe compression for a series of moving images was necessary and desirable, this characteristic of the L/C waveform could be utilized temporally as well as spatially to define an object's or group of objects' motion across a series of frames, thus allowing very precise interframe compression.

According to the present invention, two types of compression are performed on a given image. The first type of compression is applied concurrent with the source coding and is termed base compression. The second is performed on the resultant source-code and has been termed data compression.

The simplest way to encode an image with waveform coding would be to convert it into a partitive format and simply encode every line of visual data until there was a full encoding of the image that could be rendered in any digital method desired. This would however be inefficient for transmission.

Because the visual information of each line once encoded exists in a waveform it is possible to derive interstitial information that has not been coded. In other words the mapped values of the wave components of each proximate line can be analyzed and integrated with information from the surrounding lines to formulate an interstitial waveform from the two adjacent parent waveforms that is comprised of visual information not directly included in the original digitization of the image (See, FIG. 13). This information can be used in concert with waveform is derived from the orthogonal (opposite the sampling axis) to form a more complete and accurate description of that interstitial information.

Conversely, this property of waveform coding can also be used to lower bit-rates by sampling an image at specified intervals and encoding the sampling lines rather than encoding the entire image. When an image has been transmitted in a sampled format the two sample waveforms can be used, like the parent waveforms, to reintroduce the visual information that was not transmitted. This is termed value analysis line reduction and reintroduction (VALR).

The lines can be sampled at a synchronous rate to provide a defined reduction of the source-code bit-rate (i.e. 1 in 3 provides a 66% reduction in bit-rate). As the sampling interval increases the bit-rate shrinks, but there is a practical limit to the amount of information that can be removed and reintroduced, wherein elements, especially edge definition, of the original image that are generally parallel to the sampling direction are exceeded in their detail by the width of the sampling rate.

Due to the generally random nature of parallel elements in any given image it is impossible to predict what an optimal synchronous sampling rate for any given image might be. Also, given that a particular area of an image might have an abundance of parallel elements while another area of the same image might have few or none, synchronous linear sampling is basically inefficient. The synchronous linear sampling rate has two distinct inversely related costs. First if a sampling rate is increased uniformly to reduce the source code to a given bit-rate, detail in the parallel direction could be lost as a function of the edge definition (generally edge definition is not less than 3 pixels) vs. the width of the sampling rate. Conversely if the highest level of detail is accommodated uniformly the highest common denominator is determining the bit-rate as opposed to the bit-rate being determined variably by the spatial complexity of any given portion of the image. Therefore synchronous sampling of a given image can be considered to be undesirable from a transmission standpoint.

As in the ADM/AWS waveform method asynchronous sampling is used in this invention to increase the efficacy of the method, both from an image quality and bit-rate perspective. In the case of linear sampling the method has been term Asynchronous Linear Sampling or ALS. In the ALS method a component of the line header code is used to specify the following line sampling interval. In areas where there is an abundance of parallel detail, the sampling intervals would be tightly spaced, such as every two to N pixels, accommodating the highest level of detail. In areas with low levels of parallel detail, the sampling intervals are spaced according to the minimum sampling interval, as determined by object edge-definition, needed to faithfully reintroduce non-transmitted image data. The full effectiveness of the ALS method is realized in combination with waveform object marking, wherein appropriate sampling rates can be assigned to specific objects or areas.

The ALS method is also used temporally in this invention. In the case of temporal application to the L/C waveform, spatially relative waveforms within an object boundary (discussed with respect to Object Marking in the Waveform Method above) in two sampling frames are used as the sample waveforms from which a spatially relative waveform in a removed frame is reconstructed on the client side.

When ALS is used temporally, a double code is used in the object marker wherein the first element determines the spatial sampling rate and the second element determines the temporal sampling rate. The determining factors in temporal sampling of the waveform are very different from those used to determine spatial sampling rates. In the temporal case, the sampling rate is derived from a combination of the rate of change in the object's spatial characteristics and from the rate of change in the object's motion vectors. For example, an individual object rotating in one place at the beginning of a scene that later in the same scene is in motion across the frame would be sampled at different rates wherein the initial sampling rate is determined by changes in its spatial characteristics and the later sampling rates are determined by a combination of those spatial characteristics and the temporal characteristics of its motion.

The next element of the base compression relates directly to certain inherent properties of partitive image information. In any image format two types of visual information are present, chromatic and luminance data. In a partitive format, the chromatic data is singular in its nature (i.e. red in the red channel). The luminance data however is reflective of the luminance characteristics of the other partitive channels, except for portions of the image that are comprised of a single color (i.e. red) wherein the intensity of the other channels is reduced to 0, insofar as the relationship between given channels in determining the represented full spectrum color is a function of the relative luminance intensities. Therefore general characteristics of the image are found at varying levels of intensity across the partitive elements. This inherent property of partitive image data allows the employment of a multiplexed sampling method, wherein the partitive elements are sampled at wider intervals and then multiplexed so that luminance data is thereby sampled at a higher rate, appropriate to the area's edge detail, than the individual chromatic data. This method has been termed Multiplexed Linear Sampling or MLS. The interstitial line reintroduction, VALR, In MLS draws the luminance image data for a given channel from both the self and the non-self samples and adjusts the luminance intensity to the level of the self samples. As mentioned above the chromatic data is singular and therefore need not be considered with regard to VALR in a partitive method.

It should be mentioned that while they are not the preferred method of this invention, other types of sampling can use asynchronous coding and an appropriate form of value analysis reduction.

Note that while this invention does not provide methods for source coding decomposed signals, it should be mentioned that the ADM/AWS method has applications to component sinusoidal waveforms where the differential component of the codex describes changes in the amplitude and phase of the waveform over time.

In a scenario where ADM/AWS was used to encode a sinusoidal waveform, the codex would detail changes in the amplitude and phase of a series of pulses as defined at asynchronous sampling intervals. These changes could be encoded in almost the same way that changes are encoded in the case of L/C waveforms except that instead of describing changes to the wave within an L/C field the code set would describe changes to the pulse over time. ADM/AWS could provide significant advantages, dependent on the number of component sinusoidal waves and the number and nature of amplitude shifts.

After an image has been coded into a binary string using the methods detailed above the binary string is subjected to a second stage of compression. As in 16 and 32 bit code indexes, there are certain redundancies inherent in the ADM/AWS codes. Since ADM/AWS essentially encodes, temporally and spatially, oscillation in proximate L/C waveforms, the codes used to describe objects or images made up of those waveforms will be similar across the description of the object. This creates a situation that lends itself to further compression by lossless techniques.

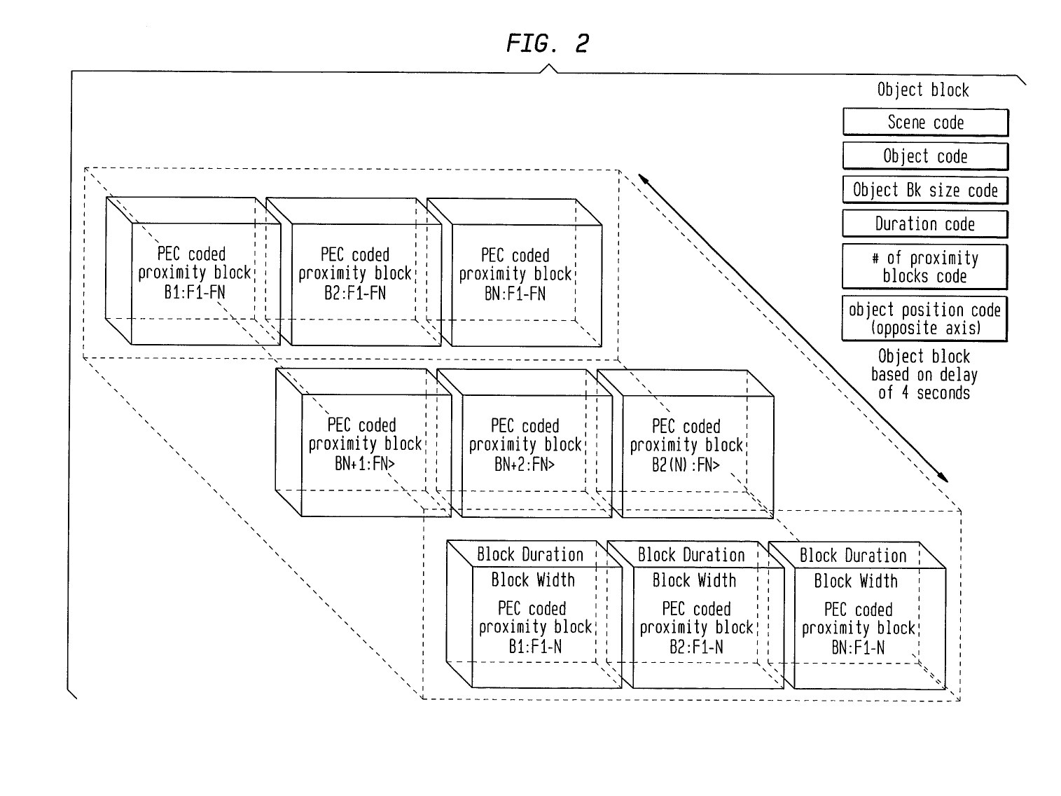

A broad overview of proximate event (PEC) coding will now be presented with reference to FIG. 2.

Proximate event coding (PEC) refers a variable-length coding method wherein a fixed or variable prefix of N bits defines the length of a subsequent variable length code word. The length of the code word for a particular binary string section or ‘event’ is fixed in a series, sub-table, and level code book structure, in which the code word's specific translation is identified by the prefix in context of its place within the compressed string.

PEC is a lossless compression method and has specific applications to data wherein a repetitive variable-order (as determined by the size of the code tables) series of binary events in proximity is likely or common. Proximate event coding has the advantage over Huffman coding of utilizing more of the possibilities inherent in variable length code words as the individual distinctiveness of the codes is based on the prefix and has reduced impact on the potential compression. The way a particular coding scheme composes a string of encoded data becomes of particular importance in a PEC scheme as the proximity of certain binary strings is more likely in certain structures than in others.

This method is most useful with regard to image data generally and particularly effective with regard to waveform coding. The nature of waveform coding both temporally and spatially implies a commonality to the encoded characteristics of proximate lines. In other words the ADM/AWS codes needed to describe a given object are similar spatially as they describe the incremental luminance and distance shifts across the object and temporally as they describe incremental changes to the object over time. This means that a given coded object both temporally and spatially will share numerous ADM/AWS binary intervals and events.

Hereinafter, the term ‘binary event’ is used to describe code intervals equal to or longer than a single ADM/AWS interval and ‘proximate event’ is used to describe the recurrent proximity of two or more binary events in a given string. The more numerous the occurrence and length of proximate events in a given string, the more susceptible the string is to compression. A series of binary events describing certain characteristics of an object are likely to be proximate in the code string to another series of binary events describing other characteristics.

Therefore, if these likely proximate events are contained in the same table only a small prefix is necessary to describe which variable length code word within the table is to be used. The less it is necessary to switch from a particular table to another table or level, as necessitated by different proximity events or singular binary events, the greater the compression that is achieved on the code.

PEC can be executed in three basic formats, namely (1) fixed length coding, (2) prefix-variable length coding and (3) suffix-variable length coding.

The following is an example of fixed length coding table: Table/level switching codes-

[01]flp 3bit vls (000)-level switch (L1-00, L2-10, L3-01, L4-11)

101 (010)-table 2

100 (100)-table 3

111 (110)- table 4

110

[11]flp 4 bit vls

[10]flp 5 bit vls

[00]flp 6 bit vls

sample string: [01]101[11]1101[00]111010(110)

table 4

Prefix-variable length coding and suffix-variable length coding can generally be described as a variable length coding scheme wherein no code sequence can serve as either a prefix or suffix to another code sequence. In other words, for a prefix variable length code, the first zero is separated, because zero is in the code table but not the start of any other codeword. Similarly, for a suffix variable length code, the last zero is separated, because zero is in the code table but not at the end of any other codeword. A properly constructed variable length code is efficient for video compression because the code is derived from the probability of a known distribution of unchanging symbols.

The following are examples of prefix-variable length coding and suffix-variable length coding tables:

0 vlp 2 bit vls

10

11

00 vlp 3 bit vls

101

100

111

110

000 vlp 4 bit vls

1111

1110

1100

1000

1010

1001

1011

1101

Nbit vlp N+1 bit vls

sample string: 00-101-0-11-000-1110-0-11

As the structure of the codebook determines whether a given series of binary events qualify as proximate events it is desirable to have flexibility in the system regarding the structure of the tables. This flexibility is achieved by incorporating a pre-defined set of N codebooks (tables) into the encoding and decoding systems. In this method this set is termed by a megatable which includes statistically likely proximity events for a given codex structure and given statistically common image characteristics. A given string is matched during the encoding to a table within the megatable structure that yields the optimum compression for that particular set of variables, codex, and characteristics.

Because of the proximate properties of the codes it should be possible to send the most common proximate N options and then generate the remainder of the table and level structure by statistical probabilities based on the most common values.

Optimal or adaptive base coding refers to manipulating the structure of the coding tables and the structure of the resulting code used in the AWS/ADM method, specifically with regard to which differential and sampling values are assigned to which binary codes and how that code is structured in the binary string. With regard to data compression the structure of a codec and the characteristics of a given set of data that it describes determine the resultant binary code's susceptibility to compression. In the case of the L/C waveform there are number of different characteristics that any given image or object could have that make it beneficial from a data compression perspective, since the tables are small or can be pre-defined, to adapt the coding structure to the characteristics of a given image or series of images. Specifically, different types of images or areas of images will be comprised of different type L/C waveforms, in terms of the differential and sampling elements, of which the proximate waveforms in an object or area are decreasing oscillations of a central or series of maximum pulses in terms of intensity and distance.

As such the differential and sampling characteristics of a series of images or an image as a whole or any part thereof share differential and/or sampling similarities, wherein certain differential values and/or sampling values or combinations are more common than others. These similarities vary substantially from one to another image or series of images. A simple example of this is the comparison of L/C amplitude shifts in a high contrast image and a low contrast image.

In either case L/C pulses of higher Intensity (greater than half the amplitude for this example) and lesser intensity (less than half the amplitude for this example) are present. High intensity L/C pulses are more common in the high contrast images and low intensity pulses are more common in the low contrast images. Therefore certain differential values are more common in one type of image than in the other. If the same coding structure is used for both images one or both resultant bit codes will be less compressible, dependent on whether the single code structure was optimal for one set of variables or a median set of variables.

When optimal base coding is performed on a given image or series of images the ADM/AWS coding table is adapted to the characteristics of the area, temporally or spatially, that the coding table describes. In the coding of a given image these characteristics are structured, in combination with pre-defined PEC codebooks discussed above, to produce a coding table that yields binary code that is optimally structured, within the parameters of the data compression applied, for further compression. The range of individual ADM/AWS coding tables can be included in the encoding/decoding system or can be sent with the binary data to be used as the decoding table for that particular image or series of images on the client side.

With regard to the structure of the binary itself, specifically as compressions like PEC apply, since the binary code is part of a broadcast, which has a delay structure, it is not necessary to simply transmit the ADM/AWS encoding as a simple linear stream as the image is coded. ADM/AWS codes are coded and arranged in limited-size structures that are more reflective of the object or images' temporal and spatial similarities and proximities.

As mentioned above the methods detailed in this invention are particularly suitable to object marking. Since changes in the L/C waveform can categorically be said to indicate the presence of an ‘object’, an object's boundary can be defined by determining the initial slope and initial plateau points of proximate pulses across a series of adjacent waveforms.

The L/C pulses in aggregate form a terrain element on a plane of base value, which is usually either the background of a given image or another terrain element in motion. Terrain features are tracked temporally across a series of frames to determine their classification and temporally accurate boundaries. For the purpose of this invention ‘objects’ are categorized as belonging to one of four classes: 1) Background object, 2) Internal background object, 3) Foreground object, and 4) Internal foreground object. Background object classes consist of objects that maintain spatially stable relationships over a series of frames, temporally, which means these objects have a low rate of motion over a series of frames. Foreground objects consist of those objects that do not retain a spatially stable relationship to other objects temporally which means that these objects have a higher rate of motion over a series of frames.

Objects are marked by utilizing the two ‘free’ codes in the ADM/AWS codex. The two codes are used as beginning and end markers where the intervening binary code indicates how the object is to be treated according to a pre-determined table. Additionally objects marked and separated by the means described herein can be assigned as ‘links’ for the purpose of interactivity wherein the marked object through the frame sequence or in a portion of the frame sequence can be automatically tagged with a content address that can be but is not limited to other video sequences or expanded content or purchasing in the case of e-commerce.

It should be clarified at this point that the term ‘object’ does not necessarily mean an actual object as such. It refers only to an aggregate L/C shift from a plane or planes of base value, such as in the case of multiple objects in motion), which might or might not be an actual object. The term ‘object’ more accurately refers to an area of luminal gestalt wherein that area could be an actual object (i.e. a face (foreground object)) or an element which defines an object (i.e. the shadow of the nose (internal foreground object)) or a random element (i.e. a patch of light on the grass behind the face (internal background object)) or a background element (i.e. the grass (background object)). This gestalt definition of visual elements is advantageous in that it defines no limits in how an object can be treated. Objects in this method can be handled independently as two dimensional shapes and as such require a simplified, less computational complex model to derive information about their motion or changes in shape.

The methods of compression generally applied to a series of images in motion can be categorized as intraframe and interframe compression wherein the temporal and spatial redundancies respectively in motion image data are exploited to achieve lower bit rates. However, the preferred embodiment of this invention uses three types, intraframe, in the form of AWS/ADM, interframe, and interstitial (ALS applied temporally) and spatially frame compression.

As described above the ADM/AWS method exploits the spatial redundancies of image data and, in combination with ALS, the spatial interstitial data derivable from two parent or sampled waveforms. As such the methods described above can be considered this method's preferred intraframe compression. There is, however, in the ALS method the opportunity to exploit the interstitial properties of waveforms temporally. As in the spatial method ALS can be applied temporally to marked objects in motion wherein dependent on an object's characteristics or rate of change over a series of frames a sampling frame rate can be set that will allow non-transmitted interstitial data to be reconstructed on the client side. Similar to the spatial method two parent or sampled waveforms are used to reconstruct the non-transmitted interstitial waveform. The difference is that in the spatial case parallel edge definition is the main factor in determining the minimum sampling rate whereas temporally the rate of change of a two-dimensional gestalt object and variability of its motion vector determines the minimum sampling rate.

As detailed above the waveform method allows precise object marking. Object marking when used in combination with ALS constitutes the interframe compression of this invention wherein marked objects within a series of frames are sampled at a frame rate determined by the object's rate of change over time. This is termed variable object frame sampling (VOFS). For example, an object with a low rate of change such as a stable background object could be sampled at rates as low as 2 or 3 frames per second wherein there is little or no change to the spatially relative sampled parent waveforms over the intervening frames and the movement of the object along the x/y axes is constant.

Conversely, in the case of a foreground object where there is a high rate of change in the shape characteristics of the gestalt object and a variable motion vector, the minimum sampling rate could be as high as 8 or 12 frames per second (based on a display rate of 24 fps).

By assigning variable frame sampling rates to different objects within a series of frames full advantage is taken from a transmission perspective in minimizing the amount of data that it is necessary to encode and transmit a series of images.

The Client-Server channel maximization method described in this invention is based on two assumptions. The first is that in any given digital transmission channel the possibility of data overflow exists to a greater or lesser extent dependent on the given channel's capacity vs. the size, per second, of the data stream or streams. Therefore it is desirable to have a method to manage the data stream and counteract data overflow in a given digital channel.

The second assumption is that a given broadcast experience will have elements that are predictable and/or repetitive. These elements can include but are not limited to commercials, self-promotional clips, and news clips. Insofar as these elements are repeated in a given broadcast or can be structured to use only a portion of the channel capacity, there exists an unused download capacity that can be utilized as a buffer to counteract the data overflow in the non-repetitive elements of the broadcast.

In this scheme server side software or hardware receives content requests from client side software or hardware. The upstream request includes an identification code that accesses individual stored server-side client information with regard to elements, commercials, etc., that have been included in previous broadcasts and therefore already exist on the client side in a memory storage device. Based upon the bit size of the elements that already exist on the client side, the bit size of the requested content, and the bit size of requested elements that do not utilize the full channel capacity (i.e., scenes that are included in the broadcast stream wherein the compressed size of the scene is less than the size, over the length of the scene, of the channel capacity), the server forwards downstream instructions regarding the use of client-side stored content and buffering in the broadcast timeline.

In this method there are three content elements that are utilized in managing the downstream data. Two are distinct types of stored content that exist on the client side, and one type that does not exist on the client side that can be used to maximize the channel capacity with regard to a specific client.

The first is classified as complete wherein the full image and sound data required to playback that content on the client side already exists in the client side storage device and all that is required is to forward a command from the server to play that content at the appropriate time in the broadcast stream thereby allowing the full channel capacity, as defined by the length in time of the content, to be used for buffering the following requested content.

The second type of cached content is classified as partial wherein elements of the content exist in the client side storage and elements of the content are included in the downstream data. Low motion speech is a good example of this second type of content in that speech can be broken down into a set number of vowels, diphthongs, and consonants wherein the wave properties of the individual phonetic sounds are directly associated in terms of producing the sound with specific facial characteristics in every individual. In other words only a limited number, as limited by the number of related phonetic sounds and facial characteristics in a given language and a given individual, of image frames are needed to represent the visual components of an individual speaking. To duplicate the appearance of that individual speaking in a given broadcast on the client side requires only to match by use of a bit code tag the appropriate phonetic waveform with the appropriate frame or series of frames needed to create the appearance of that sound being generated by the individual's vocal tract. This method is particularly useful with regard to elements such as news clips wherein the individual is expected to remain in a predictable environment.

The upstream identification tag would access server-side information on which frames necessary to a given stream of encoded speech had been previously broadcast to and existed in the client side storage and which frames would need to be included with the audio stream. From this, a bits-per-second rate is generated for the given speech scene wherein the unused channel capacity is used for buffering in the same way as with the stored elements.

The third type of content is requested non-stored content that does not require the entire channel capacity. In this case, any channel capacity that is not used in the broadcast of a particular scene is used to buffer other content. This type of buffering is used systematically throughout the broadcast to counteract any additional data overflow that cannot be counteracted by the use of complete and partially stored content. It might seem that this is merely a statement of how data is transmitted over a digital channel in that a scene that does not utilize the full capacity of a channel will stream into the client faster than the playback leaving a downstream “capacity gap’ that will automatically be used by the following scene. This method, however, differs because the content buffered in the ‘capacity gap’ is not necessarily content that is proximate in the timeline. It is not even necessarily content that is related to that particular client request. In this circumstance, the ‘capacity gap’ is utilized predictively in that the content of types one or two is sent to counteract a probable data overflow at an unspecified time in the future.

Used in concert these components of the channel maximization method are able to counteract a data overflow of around 30% (commercial to content ratio in broadcast television is 3:8) with no noticeable difference from an analogue broadcast. This figure holds true for any broadcast situation wherein a given stable channel capacity is assigned to a given broadcast. Therefore this system could accommodate multiple broadcasts over a higher capacity channel and would effectively increase a given downstream bit rate by 30%.

With the three formats that form the preferred embodiments of this invention, two separate source-coding methods present themselves as most viable for each respective format. These methods are waveform in the case of three color-red, green and blue (RGB), and tubiform in the case of R/M, B/C, and G/Y (six color) and full color, tubiform (R/M B/C G/Y and full spectrum)

The tubiform coding method (TCM) is similar to the waveform method in that it employs a variation on the ADM/AWS coding scheme. It differs though in that the mapped forms that it codes can no longer be termed even ‘atypical waveforms’ since they are three-dimensional in nature. This invention refers to them, for lack of a better term, as tubiforms. The tubiform coding method (TCM) also accommodates a variety of formats between six color and full spectrum color.

In the case of tubiform coding methods, the partitive or full color component units that comprise a single line of visual information are mapped according to their L/C values in a cylindroid or circular matrix L/C gradient field of at least two colors. Perhaps the best way to describe this field is as a series of circular color gradients stacked vertically with each slice corresponding to a single unit of length in the image line. Due to the three dimensional nature of the coding method the directional coding element in the ADM method is modified to encode multiple angular vectors.

As with the waveform method once a given line of quantized partitive or full spectrum visual information has been mapped within the L/C matrix as a tubiform it is susceptible to coding. In the case of the tubiform, as in the case of waveform, the sampling intervals are coded by the ASW method at mapped changes of the tubiform in the L/C matrix. A planer differential value is then coded by means of the ADM method indicating a possible differential circumference of the L/C value change at the ASW sampling interval. Then the angular vector along the two-dimensional plane is coded to specify a point of defined L/C value within the general circumference marked by the ADM code. For this invention this differential method is termed angular vector asynchronous differential modulation (AVADM).

In the full spectrum format an additional coding element is added to determine which type of L/C shift is indicated by the original image information. This coding element describes one of a set number of transition phases for the tubiform. The transition phase constitutes an instruction for how L/C shifts between distinct hues are represented.

Tubiform coding is not as effective as waveform in that its bit rate is generally double that of waveform. Additionally, it is less susceptible to optimal base coding than waveform and therefore less susceptible to data compression. Tubiform is intended as an alternative for higher capacity channels and in this regard has a large bit-rate advantage in source-coding full color over 16 bit.

An input signal representative of a video or still image is received in a digital or analogue format by an array having a plurality of processors, such as but not limited to a shared memory array (Symmetric Multiprocessing (SMP) Architecture), and converted into a digital partitive format, in the case of this embodiment RGB. The signal is split into its component channels, R, G, and B. Each channel is sent by means of a high-bandwidth system bus to three or more separate shared memory arrays and further partitioned into N frame sets as determined by the length of time in which a given frame set is processed through the system, which preferably is equal to or less than the broadcast delay, and the number of processors available in the subsequent array.

The frame sets are output from the shared memory arrays to disks or the next array, dependent on processor availability in the next array, via a high-bandwidth system bus. The frame sets are transferred via the system bus to an array having a plurality of processors, such as but not limited to a parallel array (Massively Parallel Processor (MPP) Architecture). Different frames sets are assigned at a rate of 1 frame or a portion thereof Unquantized channel data is sent to a memory storage device for later comparison to encoded and decoded samples.

Individual frame data is quantized into n levels based upon m level values assigned in the original digitization (in normal RGB 256). The value of n is determined as a function of a given channel capacity, a maximum base compressed frame size, and a minimum data compression rate (bit length):

$$n ≦ 2 ( ( \frac{b}{{m}_{c} ( {c}_{s} ( {h}_{c} + {m}_{is} ) )} ) {C}_{aws} - 1 ) + 2 and ,$$

alternatively stated,

$$n = 2 \{ [ b / {m}_{c} ( {c}_{s} ( {h}_{c} + {m}_{ls} ) ) ] {c}_{aws} - 1 \} + 2 , or$$

$$n < 2 \{ [ b / {m}_{c} ( {c}_{s} ( {h}_{c} + {m}_{ls} ) ) ] {c}_{aws} - 1 \} + 2$$

where,

m_{c}=minimum compression rate

1s=# of linear samples

h_{c}=size of header code

m_{LS}=maximum sampling intervals per linear sample

c_{AWS}=AWS/ADM codex bit length

b=bandwidth in bits of desired transmission channel

The frame is then split into component linear samples of 1 by Ypi each marked by a header code. The linear samples are plotted in a linear L/C gradient field of X amplitude and Y length representing the luminant and chromatic possibilities, as determined by the quantization, in that partitive channel and for the purpose of the base coding form a sampled waveform described by the individual consecutive pixels of the linear sample plotted within the amplitude of the field. Each pixel is given a bit code definition of its place within the L/C field. This constitutes a 1 to 1 sampling rate and provides the L/C waveform basis for the next stages of coding.

The L/C waveforms that constitute a given frame or series of frames in a given PU are then subjected to a level and waveform analysis with look back/look forward/look sideways frame data shared between PU's in the given array. The L/C values of the pixels and the characteristics of the L/C waveforms within a quantized and plotted frame are compared to previous and following frames throughout a given sequence, as limited by a change of sequence or achievable inter-processor communication, for areas of stability and instability as described in the summary. In this analysis, areas of spatial stability, as defined by the waveform and value characteristics of a given area not the x/y axis characteristics, are determined first and the areas of instability are defined as the areas that are not included in the areas of stability. The areas of stability and instability are then marked in each frame, preliminarily, as background and foreground objects respectively, and compared across the given sequence for component elements or gestalt objects. The gestalt objects are compared within a given area of instability or stability both temporally and spatially to determine the gestalt object's parameters over time and whether a given object is internal to an area of stability or instability or external.

From this comparison each independent, in terms of spatial and temporal characteristics with regard to other objects, gestalt object within the sequence is marked in the pixel code with a ‘free’ code (i.e., ADM/AWS method) prefix, defining the boundary of the object, a type code of two bits that identifies the object as an internal or external background object or an internal or external foreground object, a specific object-identification code as determined by the number of objects within a given sequence that marks the object through the sequence regardless of its position within the frame or rate of change over the sequence, and a ‘free’ code suffix.

With regard to object separation the process is performed as follows:

The frames comprising a given scene as determined by a time code header have been encoded with a quantized L/C value for each pixel within each channel of red, green, and blue. Taking the 2^{nd} frame or frame n as a central comparison sample for the 3^{rd} frame or frame n+1 and the 1^{st} frame or frame n−1, the L/C values in the three are analyzed for at least three areas of matching spatial value with regard to the relative arrangement and values of the component pixels in the given area. These areas are compared and identified independent of their respective x and y coordinates and relative angular position for the purpose of object marking. Once three or more, preferably at least six, matching areas between the three frames have been found these matching areas provide the basis for the comparison of the frames for areas of stability and instability. When areas of instability and stability in the three frames have been identified within a given threshold as determined by the amount of noise introduced in the recording or original encoding process these areas are tagged and frame n+1 is taken as the next central comparison frame. Motion vectors are calculated for both the areas of stability and instability between frame n and n+1 and are used to calculate a predicted area of comparison for frames n+1 and n+2. This process is continued until the end frame of the scene.

One concern in this method of object separation is the potential inability to identify areas of stability or instability in certain unusual types of scenes, such as very high motion tracking shots, wherein there are no inherent areas of stability or instability in the scene. In these cases or in any failure by the encoding system to identify areas of stability and instability in a given scene the entire frame area is considered a foreground object and is encoded by the methods described herein.

The L/C waveform encoded frames from all channels are sent via a high-bandwidth bus to a shared memory array wherein the marked objects in the different channels are compared, separated from the parent frames, and sent to a storage device for later comparison to encoded and decoded objects. A buffer of N pixels is given on either side of an object boundary and coded into both the bounding and bounded object. A frame and opposite axis, opposite to the sampling axis, placement code is then attached to the header code of the initial linear sample of the object. In cases where an object is constituted of information from two or less channels and was not marked in the remaining channel, the object is marked in that channel and coded with a special code in all channels whereby at the multiplexing stage of the method that channel's sampling assignments can be transposed with the concurrent sampling from the most ruminant channel.

The objects are then divided into N object sets, constituted of object frame sequences, and sent via high-bandwidth bus to the next parallel array. The object sets are assigned to sub-sets preferably constituting 1 object frame or a portion thereof

The waveforms that constitute a given object in a given frame are subjected to an ADM/AWS analysis wherein an optimal combination of ADM and AWS differential and sampling values for the given waveforms is derived within the parameters of the pre-defined ADM and AWS codebooks. After an optimal codebook has been assigned the waveforms are coded by ADM/AWS methods. Three methods are presented in this preferred embodiment but any scalar or vector waveform encoding method could be used to encode an L/C linear sample wherein the bit rate was sufficient to the desired channel's capacity. The waveform encoding methods described in this invention are similar to variable step size methods generally found in the area of numerical integration of differential equations, such as the Runge-Kutta method or multi-step backward differentiation methods.

One way in which to implement the ADM/AWS method involves the following steps:

The first (initial) value is saved. The next value is gotten. If this value does not differ from the first, the next is checked until it does, and the length is stored and a difference value of 0. If it does differ, the next value is gotten. If the difference between the first two is the same as the difference between the second and third values, the next value is gotten, etc. This is continued until the difference is not the same. The location of the last pixel that was the same is stored, and the total difference is stored. This draws a segmented line. If a threshold is used, it approximates the curve with a quality inversely proportional to the magnitude of the threshold. In order to limit the bits needed to encode the magnitude of the difference, values of 3, 6, 11, 18, 27, 38, 51, and 66 for example could be the only ones used, and all others are rounded to the nearest. In order to limit the number of bits needed to encode the distance to the next sampling point, an upper boundary can be placed on the length, i.e. if there is no change for 70 pixels, it can be encoded with two codes telling it a length of 32, and a difference value of 0, then a code with length 6, and difference 0). This allows the length to be limited, making all of the length codes 5 bits in length, providing tremendous savings in the long run, because that may be all that is necessary much of the time. Depending on the speed of the encoding processor, and time necessity, either a variation of Bresenham's line algorithm, or a Bezier Curve algorithm will be used when extrapolating between samplings.

Another way to implement the ADM/AWS method involves the following steps:

The derivative is calculated at the first 1 to 1 sample. This step is repeated with the next 1 to 1 sample until the value of the derivative exceeds a set threshold value as determined by the desired bit rate vs. precision of the encoding. This sample step is stored and the process is repeated with the next 1 to 1 sample. This process is repeated until the end sample of the linear sample. The sample steps are then compared to n ADM/AWS tables for a table that matches or can combinatively reproduce the stored step sizes. The steps are then split into their component ADM AWS values and encoded according to the given table.

A third way to implement the ADM/AWS method involves the following steps:

The initial 1 to 1 sampling value is compared to the following value. If the values are the same the next sampling value is compared to the following value and the process is repeated until the sampling value is different. The value before the different value is stored and assigned as the low value. The samples following the different value are then compared. If the value of the following sample is greater, that value is taken as the comparison sample and the process is continued until the sample value is either the same or less than the current comparison value. The value before the same or lesser value is then assigned as the high value. The curve as described by the 1 to 1 samples within the L/C gradient field is analyzed for the inflection point. The low value, the high value, and inflection point are then stored. Chords are then drawn between the low value and the inflection point and the inflection and the high value. These constitute the basic ADM/AWS sampling points.

The points are then encoded as described above in method 2 and decoded and the decoded waveform segment is compared on a 1 to 1 sampling basis with the original 1 to 1 sampled waveform segment. If the result is a satisfactory replication of the original waveform, the sampling points are stored and the process is repeated from the same or lesser value after the high value. If the result is not the satisfactory replication of the original two segments around the inflection point then the chord of the unsatisfactory segment is assigned as the x axis. The angle of the original chord is stored. The initial value of the segment is assigned as the low value and the comparison process is performed to arrive at a high value. The high value is then stored as an ADM/AWS sample relative to the chord and the chord is readjusted to its original angular value relative to the main x axis. The wave segment is then encoded and decoded and compared to the original 1 to 1 sampled wave segment. If the result is a satisfactory replication of the segment the encoding is stored and the process is repeated from the value following the original high value. If the result is not satisfactory the chord process is repeated with last set of chords until the result of the decoding is the satisfactory replication of the original segment.

The resulting ADM/AWS coded objects that constitute a given object in a given frame spatially and a given series of frames temporally are subjected to an ALS analysis wherein the component coded waveforms of the object are analyzed to determine the minimum linear sampling rate by which interstitial waveforms can be derived from the sampled waveforms that can be said to closely, as defined by the human visual system, approximate the original component waveforms that were not transmitted.

ALS analysis constitutes starting with the initial marked linear sample named herein L1 and the Nth consecutive linear sample (as determined by the minimum assigned sampling rate) named herein LN and deriving mean x (along the AWS axis) and y (along the ADM axis) values for the pixels in the interstitial line or lines.

The mean waveform or waveforms (i.e. if lines 1 and 4 are sampled arithmetic means of the sampling intervals is used to derive lines 2 and 3) are decoded and compared to the original waveform or waveforms between L₁ and L_{N}. In a given sequence wherein the object's component waveforms L₁, L_{N}, as determined by the set minimum line sampling rate.

Interstitial waveforms' x and y sampling interval values are derived by the formula:

$$( {x}_{l} , {y}_{1} ) at {d}^{2} / y / {dx}^{2} = 0 , {v}_{l} = {f}^{′} ( x ) \vert {x}_{l} , \frac{{v}_{N} - {v}_{I}}{N - 1} = α$$

where V_{I}, V_{N}, and α are vectors and where V_{I} represents the value of pixel and V_{N} represents the value of spatially relative pixel x in the waveforms LF1(1), LF1(N) and LF2(1), LF2(N) and N is the number of frames or lines removed.

The interstitial waveforms as derived from the sampling intervals are decoded and compared on a one to one basis with the uncoded waveforms. If the result is the satisfactory replication of the original uncoded waveforms the next linear sample is taken, LN+1, and the process is repeated Y times until the resultant decoded waveforms, as defined by their 1 to 1 sampling values, vary unacceptably from the original waveform or waveforms that have not been sampled. The sampling rate is then encoded in the header code of the initial linear sample, L1, and the process is repeated with the next linear sample LN+Y and so on until the object's spatial ALS rates have been determined.

Upon decoding for comparison to determine the spatial and temporal ALS rates there are two basic methods by which the interstitial ADM/AWS waveforms can be reintroduced. The first has a greater degree of accuracy and computational complexity.

1) The ADM/AWS sampled waveforms are decoded to waveforms with a one to one sampling rate. Slope information with respect to the characteristics of the luminance pulse is derived by the tangent line or Euler method. The resultant tangents are compared by means of a set or variable angular threshold value to determine the relative tangents with respect to their wave segments. The pixels within the wave segment in sampled line 1 as defined by the tangential partitions are compared to the pixels within the relative segment in sampled line 2. From this a component pixel number is derived for both segments and subjected to an analysis wherein the relative pixels between the two segments are determined. These relative pixels are subjected to a mean value analysis in which the specific L/C gradient field value for a given relative pixel in L1 is compared to a relative value or values in line 2 and the mean values are determined according to the ALS rate contained in L1's header code. The interstitial values are dependent on whether the relative pixel in L1 has more than one relative pixel in L2. If the relative pixels are singular then the arithmetic mean of the two relative pixels is sufficient. If the relative pixel in the L1 segment has multiple relative pixels in the L2 segment or the converse is true then means are derived for each relative pixel set and those mean values are then used to derive means for the interstitial pixel values from the removed waveform or waveforms. This technique can be applied both to spatial and temporal ALS encoding and decoding. With respect to temporal ALS (VOFS) an additional step is necessary to determine relative waveforms between two temporal instances of the given object.

2) The second ALS method decodes directly from the ADM/AWS sampling intervals. Slope information from ADM/AWS interval 1 and 2 in sampled line 1 is similar to the information derived above by the Runge-Kutta method in that the Runge-Kutta stepsizes and the AWS sampling rates are both variable. It is assumed in this technique that by the nature of their encoding ADM/AWS sampling intervals will to a large degree duplicate the information derivable by the Runge-Kutta method. The slope values derived from these intervals are compared by means of a set or variable angular threshold value to determine the relative ADM/AWS intervals. The difference between this method and the first is that the ADM/AWS segments are not necessarily determined by number but by compound relative elements. In other words a line segment determined in the above method will be singular in nature with the relative differences defined by the relative 1 to 1 sampling associations. With regard to ADM/AWS however, the relative wave segment in L1 might be described by two ADM/AWS intervals whereas the relative segment in L2 might include three ADM/AWS intervals. In the case of direct ADM/AWS interval ALS decoding both singular and compound slopes are analyzed to determine relative segments.

Error control for the compressed code will now be discussed with reference to FIG. 10.

An error check on the relative ADM/AWS analysis is performed between the derived slope information and the directional component of the ADM/AWS code. As the directional code indicates slope direction relative ADM/AWS samples should share the same directional codes. Interstitial ADM/AWS intervals in the removed lines are then derived by the same methods described above but with substantially less computational complexity. Once the interstitial intervals have been calculated the interstitial lines are decoded according to the ADM/AWS decoding method. Motion paths can be marked by preset in object code.

Temporal ALS (VOFS) is preferably performed after the spatial ALS. The uncoded objects from the stored memory device are subjected to an analysis wherein the spatial characteristics of two object frames are compared in the direction opposite to the sampling axis to identify spatially relative linear waveforms between the two frames.

Once the relative waveforms in the two frames have been marked, information from the spatial ALS coding is used to determine which of the relative ADM/AWS coded waveforms are to be subjected to temporal ALS. Temporal ALS constitutes starting with the first object frame, F1, in a given sequence wherein the object's component waveforms LF1 (1), LF1 (N) have been identified according to their spatial characteristics as relative to component waveforms LFN(1), LFN(N) in the object frame FN (as determined by the minimum assigned sampling rate), as determined by the set minimum frame sampling rate. Starting with the initial marked linear sample named herein LF1 (1) and the Nth temporal linear sample (as determined by the minimum assigned frame sampling rate) named herein LFN(1), the mean x (along the AWS axis) and y (along the ADM axis) values are derived in the interstitial line or lines. Interstitial frames' waveforms' x and y values are derived by the formula:

VN=V1+(N−1)d

where V1 represents the value of y pixel and VN represents the value of spatially relative pixel x in the relative waveforms LF1 (1), LF1 (N) and LF2 (1), LF2 (N) and N is the number of frames or lines removed. The interstitial values are:

ƒ(V)=V1+d, V1+2d, . . .

In certain cases wherein an objects' spatial characteristics in the opposite axis are not equivalent, N waveforms in one object's temporal instance are assigned as relative to N waveforms in the second object or the reverse. Certain waveforms might or might not be assigned to two other waveforms. In these case N mean values are derived for the interstitial waveforms between the N and a singular waveform, using the initial waveforms as a base, and then the N mean values are subjected to a mean value analysis wherein the number of means is determined by that frames place within the interstitial series (F1, F2, F3, . . . FN) and the relative values of the waveforms

The resulting interstitial waveforms are then compared on the basis of the component L/C and X/Y values with the component waveforms in the removed object frame or frames. If the result is the satisfactory replication of the original uncoded waveforms, the next linear sample is taken, LN+1, and the process is repeated Y times until the resultant decoded waveforms, as defined by their 1 to 1 sampling values, vary unacceptably from the original waveform or waveforms that have not been sampled. The temporal sampling rate is then encode in the header code of the initial linear sample, L1, and the process is repeated with the next linear sample LN+Y and so on until the object's temporal ALS rates have been determined.

The ADM/AWS/ALS encoded objects from all channels are sent via high-bandwidth bus to a shared memory array. The respective channels are subjected to an MLS coding wherein the linear sampling intervals for the individual partitive channels are multiplexed. The multiplexed objects are then decoded for comparison to the stored one to one sampled waveforms in the respective channels.

In MLS decoding a reverse multiplexing is applied wherein the self samples in a given channel draw L/C pulse intensity and luminance information from self samples and only luminance information, with regard to waveform variations within the L/C field which can characteristically be said to embody object detail at varying levels of intensity between the channels, from non-self samples. In cases where a particular channel's linear sample contains a flatline at a set level within the L/C gradient field, non-self information is derived from the remaining non-self channel or dependent on a particular implementation the flatlined channel can be alternately transposed with the remaining channels' linear samples. In cases where flatlines are transposed this and the transposed channel's flatline level is indicated in the object header code.

After MLS encoded object sets have been decoded and compared to the original stored objects with satisfactory results on a one to one sampling basis, the individual object codes are separated into intervals of N seconds wherein N can constitute a full second, seconds, or fraction of a second, and the temporally concurrent object codes are assigned a place within the scene bit stream. At this stage in the encoding process the objects are still linearly encoded, i.e. line by line.

The bit stream is sent via high-bandwidth bus to a decoding device that decodes the stream with a client side replicative software or hardware decoder, as described below. The frames' component ADM/AWS/ALS codes are decoded to a one to one sampling basis in the L/C gradient field and then subjected to a reverse quantization wherein the waveform is scaled along both the x and y axis to the original unquantized encoding proportions. The channels component image lines are then compared to the original unquantized linearly partitioned channel data. A comparison is applied on a pixel by pixel basis to determine the deviation between the original data and the decoded data. If the rate of deviation falls below a certain pre-assigned threshold as determined by given channel capacity and the human visual system the encoded data is considered ready for transmission or data compression dependent on channel capacity and the rate of the encoded bit stream.

If the data rate exceeds the given channel capacity of the desired transmission method the ADM/AWS/ALS data is sent via high-bandwidth bus to a shared memory array. Dependent on the capacity overflow rate with regard to the transmission channel and the encoded image data, the encoded data is subjected to a series of lossless data compressions. If the data is intended for storage these operations are performed automatically to reduce the encoded data to a desirable storage rate. From storage, these data streams can either be transmitted directly or if bandwidth allows partially decoded prior to transmission to reduce client side computational complexity.

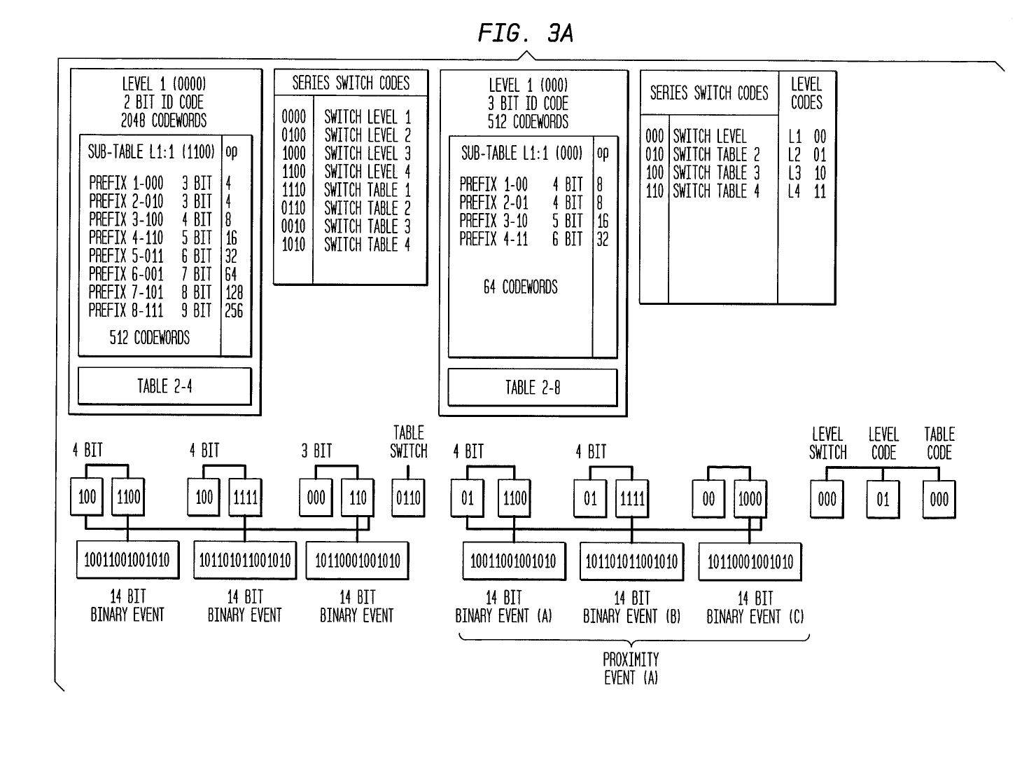

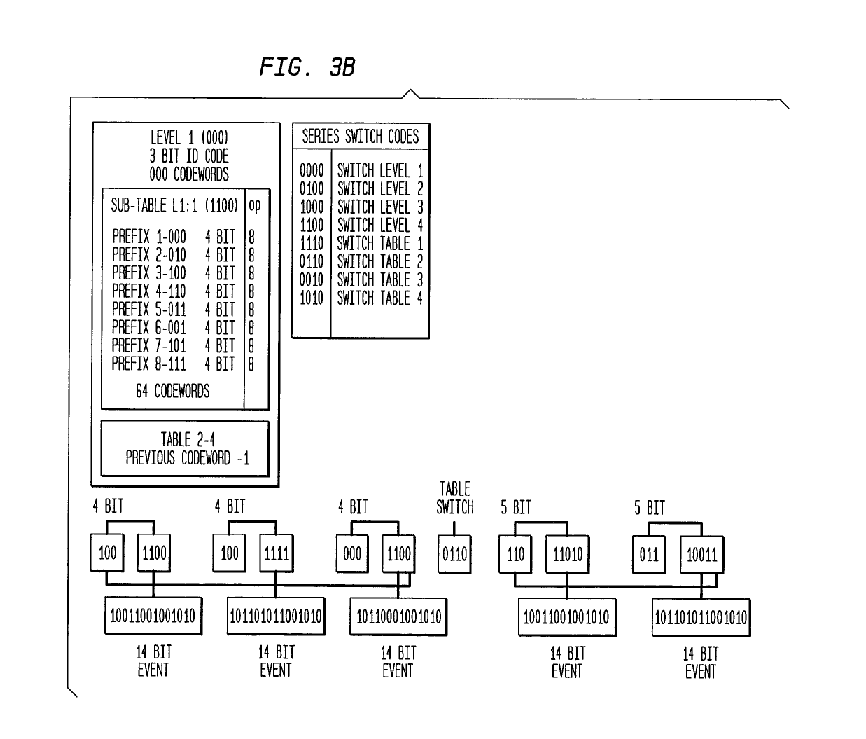

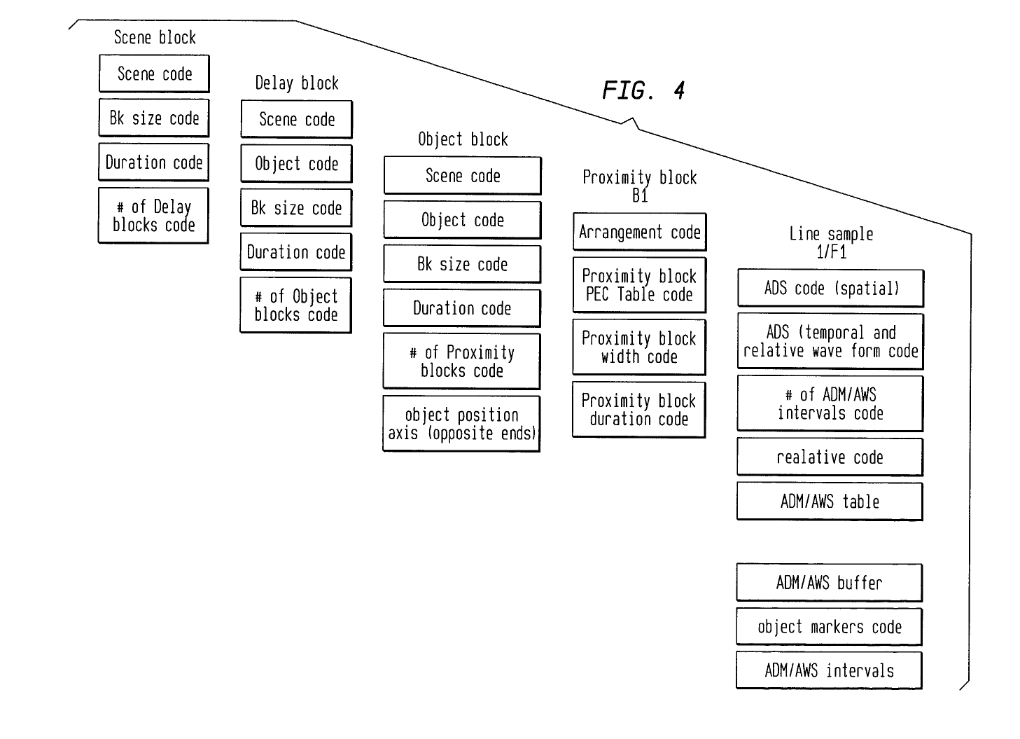

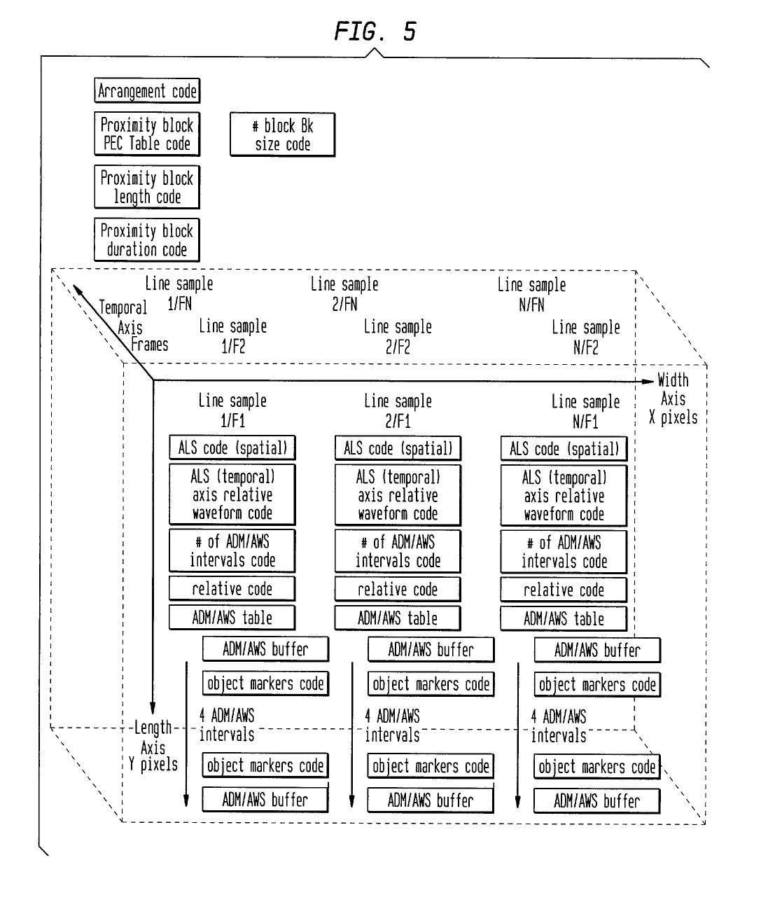

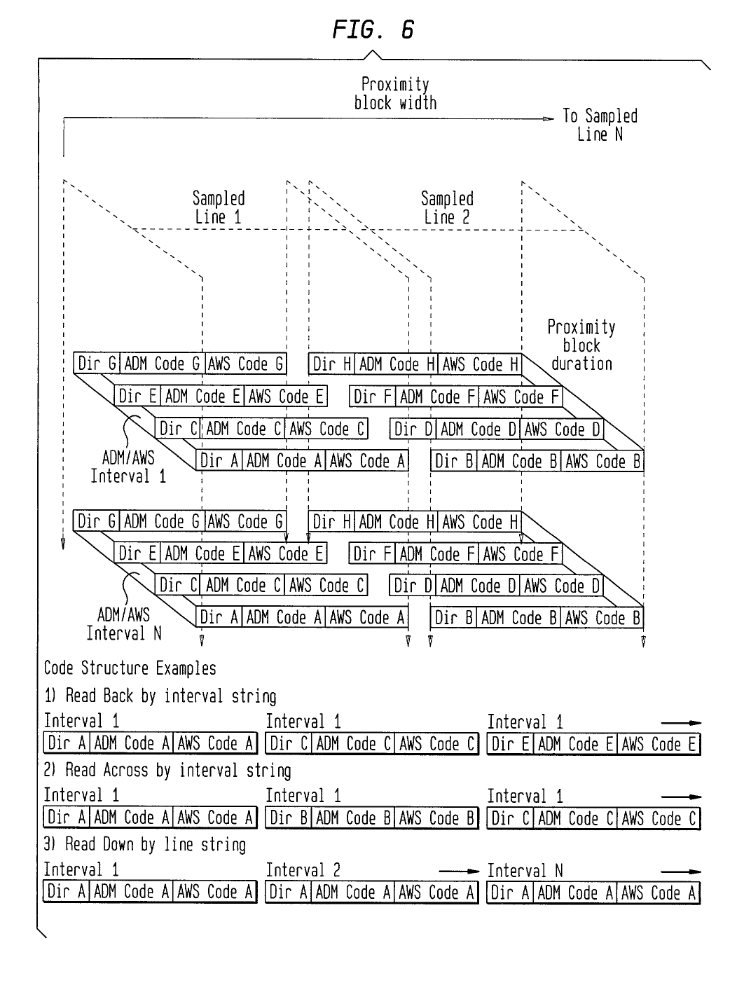

The first compression applied to the encoded data is a PEC variable length encoding, and will be discussed with reference to FIG. 3. The first compression is a PEC variable length encoding wherein the data's binary and proximate event characteristics are matched to an optimal variable length codebook that is part of a PEC mega table of pre-determined codebooks in both the encoding and decoding systems. In order for this operation to be performed, the data stream partitions described above are separated into the component object data. The object data is then represented three-dimensionally wherein the Y axis represents the encoded linear duration of a particular waveform, the X axis represents spatially proximate encoded waveforms, and the Z axis represents the temporally proximate encoded waveforms. The data is represented this way to match a particular data-read direction with the proximate and binary event characteristics of a particular proximate event coding (PEC) codebook.

Proximate event coding achieves compression on the principle that ADM/AWS codes share general similarities temporally and spatially with regard to a given object due to the incremental nature of the coded waveforms. Furthermore with regard to a given set of object image characteristics a combination of those characteristics will determine the most desirable way in which to construct the data stream for PEC compression. Data is read along the X, Y, and Z axis. For objects with a high rate of temporal change a desired data arrangement is along the X axis. For objects with a high rate of spatial change a desired data arrangement is along the Z axis. For objects with a high rate of temporal and spatial change a desired data arrangement can be along the X, Y, or Z axis. In any given set of ADM/AWS coded object data, arrangement along a particular axis will yield the greatest number of proximate events.

The three data arrangements are compared to the codebooks in mega table nodes based on statistically common object parameters. The data arrangements are matched to codebook groups to determine a particular codebook that yields the highest use of top-level tables and the least inter-table and inter-level switches with regard to a particular data arrangement. Dependent on the general size and characteristics of a particular object one or more PEC tables can be used in encoding the object data. In this case, the areas of data encoded by a particular codebook are called proximity blocks, which include arrangement, width, based on linear samples, and duration codes that define the boundaries and data arrangement of the proximity block.

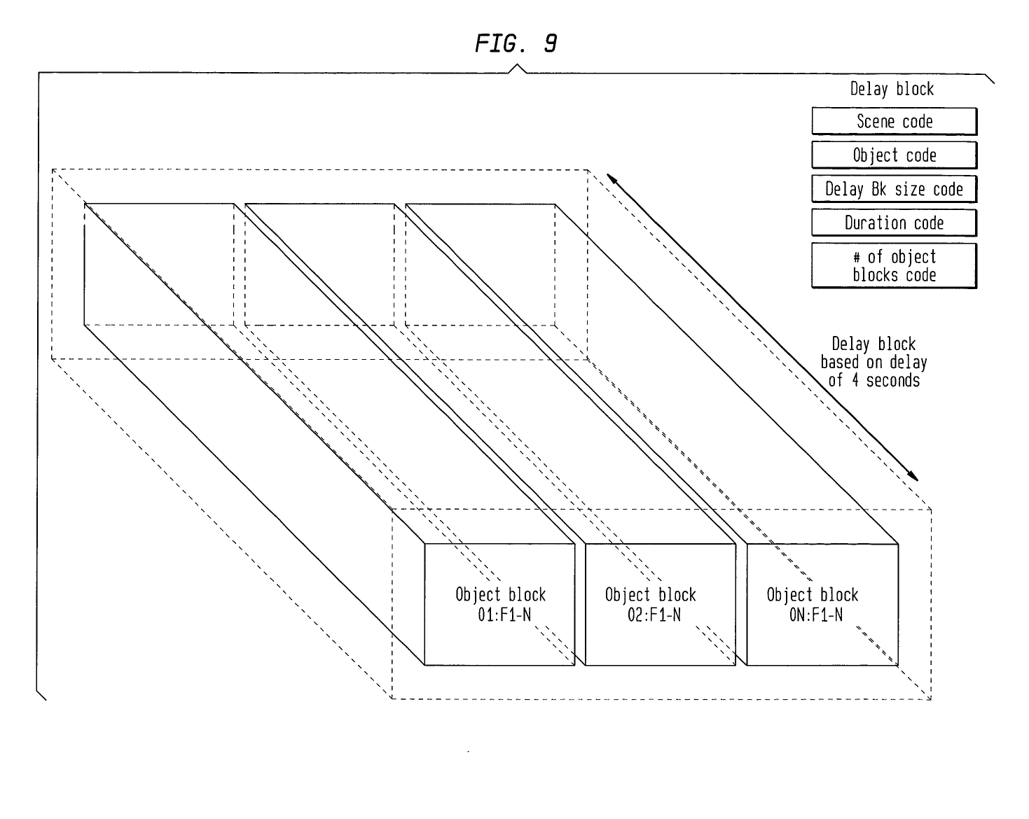

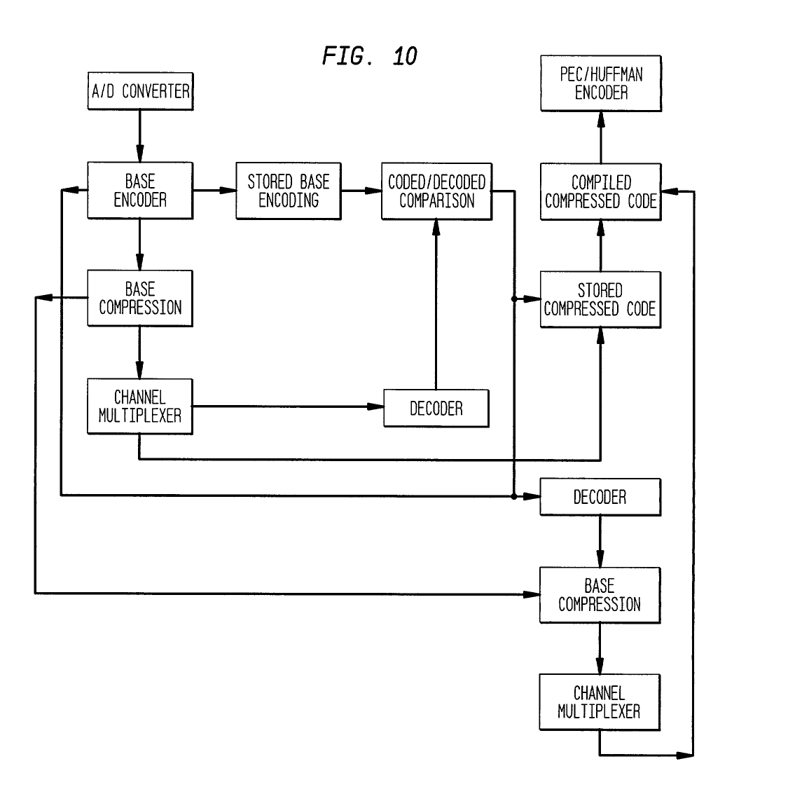

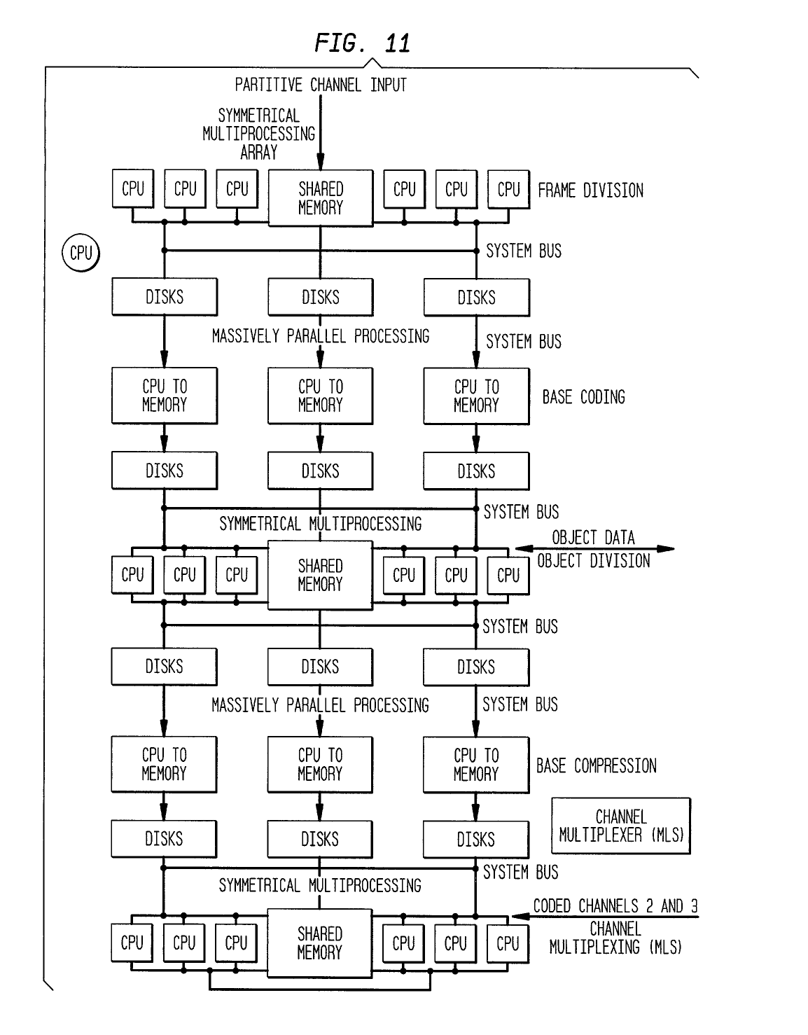

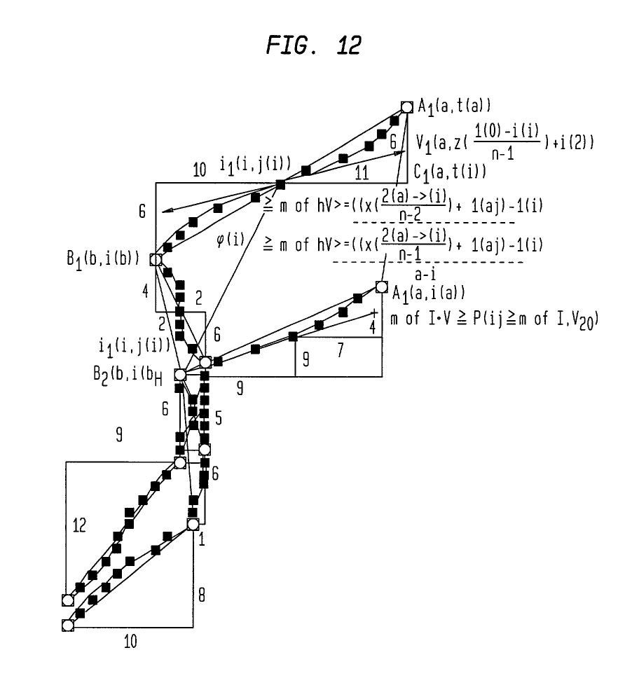

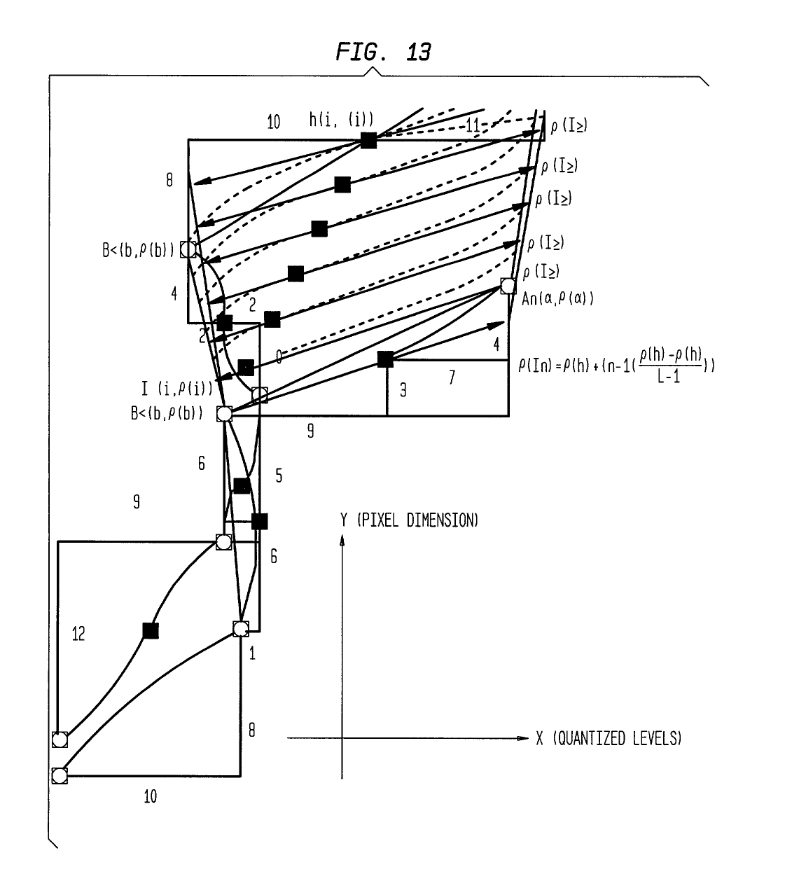

As shown in FIG. 9, an object's proximity blocks are grouped to form object blocks, which in turn are grouped to form delay blocks. Each block also includes a linear duration code that defines the binary data stream boundary of the block.

An error check on the relative ADM/AWS analysis is performed between the derived slope information and the directional component of the ADM/AWS code. As the directional code indicates slope direction relative ADM/AWS samples should share the same directional codes. Interstitial ADM/AWS intervals in the removed lines are then derived by the same methods described above but with substantially less computational complexity. Once the interstitial intervals have been calculated the interstitial lines are decoded according to the ADM/AWS decoding method.

The Runge-Kutta Method will now be discussed. Fourth order Runge-Kutta-Fehlberg and Bulisch-Stoer methods are variable stepsize integration methods; whereas, forward Euler's method is a fixed stepsize method. A/D and D/D System for encoding and decoding Live and Pre-recorded Broadcasts involve the following steps-Receive signal from image source and digitize; Correlate and convert data to compression specific format; Compress source data into bit code for transmission; Decompress bit code and check against original uncompressed data for acceptable variations; Recalibrate source data and compressed data; Send compressed bit code to client or storage server; Client receives bit code decompress and display.

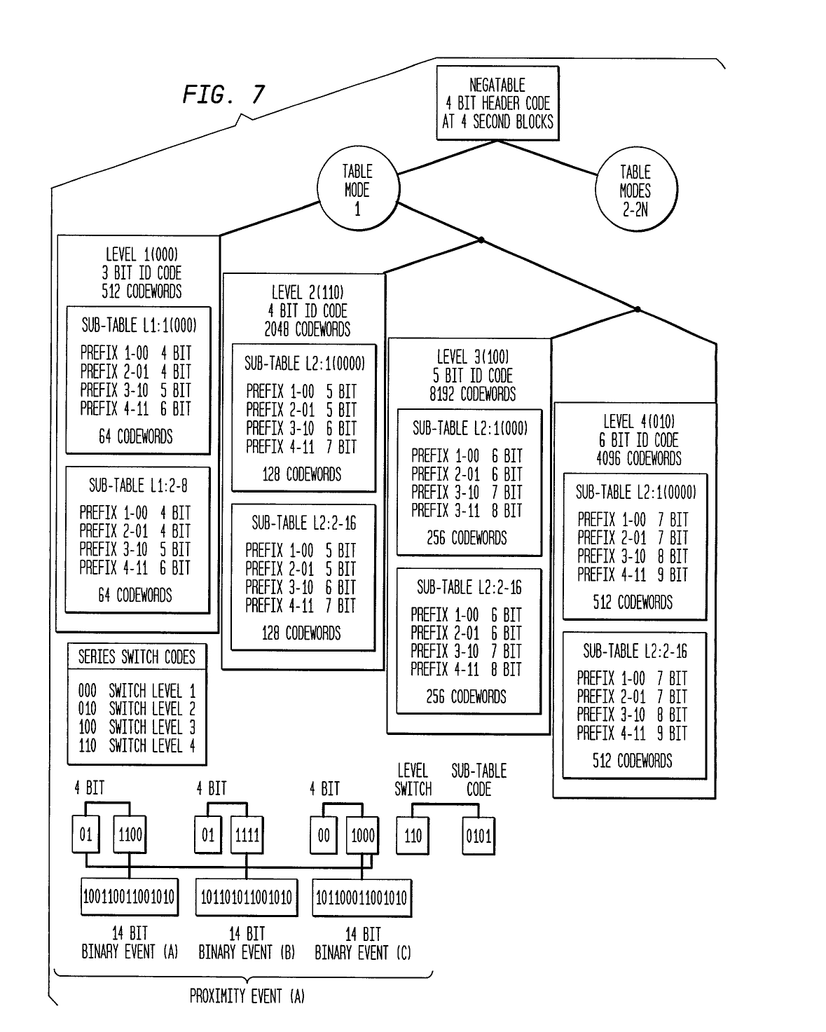

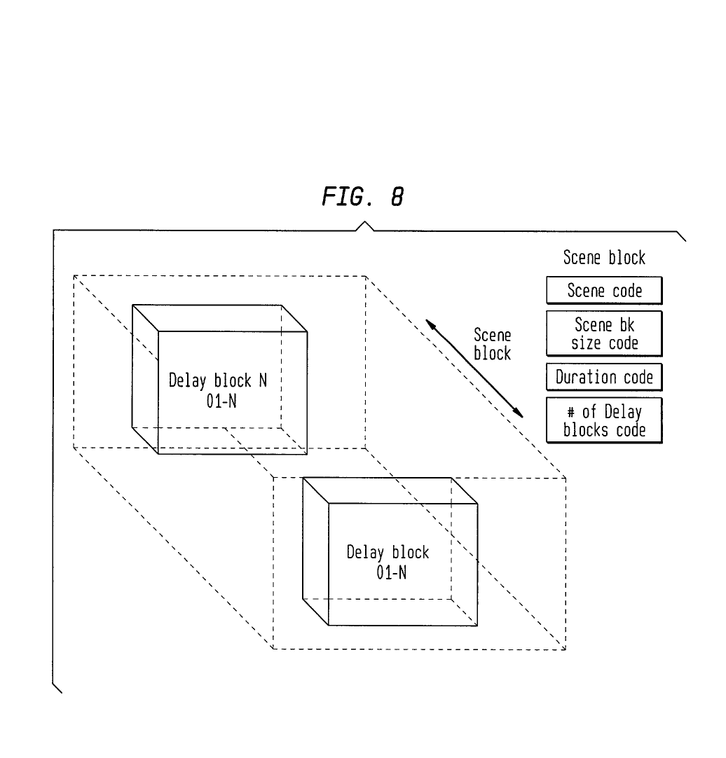

Motion and Still picture encoding and decoding steps will now be discussed with reference to FIG. 7.

Convert A or D signal to digital partitive RGB format and reduce to y luminance levels line sample channels (asynchronous, synchronous, or multiplexed) at an x rate where x=plot line sample as variable wave in predefined chromatic/luminance matrix (gradient field) generate code description for wave through asynchronous differential modulation and asynchronous or synchronous sampling. Subject differential modulation and differential sampling codes to independent compression. Insert boundary code for sampling lines. Multiplex compressed codes for transmission over digital channel or storage in digital storage unit. Decompress and decode on the client side to reproduce original wave in the pre-defined gradient field use sampling lines self and non-self to reconstruct non-sampled lines. Display either line formed partitive image or merged channel image, depending on client-side capabilities and channel capacity.

Section 2: Single frame bit code reduction versus multi-frame bit code reduction

In order to create an experience competitive with analog TV over limited capacity channels, said experience must be completely duplicative of analog TV and as seamless as the off-line broadcast experience. Especially in the low bandwidth environment this necessitates a system by which the downstream rate of transmission is maximized both from a quality and content point of reference. Buffering is the hallmark of any internet streaming experience and it is by no means seamless. But does it have to be that way? To answer this question the elements that comprise a typical broadcast experience must be looked at individually in terms of time, frequency, and flexibility.

Simply stated, the elements that comprise a typical television viewing experience comprise (1) desired programmed content (i.e. news, sit-coms, music videos, movies, etc.) (2) corporate advertising, (3) self-promotional advertising, and (4) the ability to change the channel.

The first element is the reason the viewer is involved in the experience. The second element is that to which the user is subjected to pay for the experience. The third is the broadcaster's attempt to convince the user that they are his optimum provider of the first element (i.e. branding) and to convince him not to exercise the fourth element. The fourth element allows the user to avoid the second and third element.

At first glance, it would seem that broadband transmission, such as a 56 KHz television (TV) signal, would immediately be unviable commercially because the relatively narrowband width (compared to 6 MHz bandwidth of broadcast and cable TV) would immediately deny the viewer the most important and flexible element of his experience, the ability to easily change the channel without interrupting the flow of his desired programmed content. However, the bandwidth forces any provider of 56 KHz TV into a content on demand model which arguably counterbalances the negative experience of not being able to change the channel.

Looked at from this perspective the first element remains highly flexible perhaps even more flexible than in the off-line broadcast process.

Also, elements 2 and 3 become fixed and unchangeable as a trade off for content on demand just as they are a trade off in the off-line process. Since they are fixed elements in the experience, there is no reason to wait for a viewer to access them. In other words these elements could be sent downstream while the user is selecting his optimum content or in any open gap in the downstream bandwidth and stored in his computers cache memory for later use. After selecting his content for the next hour, the commercials, self-promotional, and news (see next section) programming could be used strictly as pre-cached buffers in the 56 KHz environment to create what is to the viewer a normal seamless TV experience. It would be an experience with one distinct advantage over off-line broadcasts, not having to change the channel to watch the optimum desired content.

Buffering Formula for downstream maximization:

x=((mw−mn)(y))/z

x=sp or commercial cache buffer in # of sec

y=content length in # of sec

z=download rate through modem

w=avg. frame size of content

m=content frame rate per sec

n=avg. frame size of content after buffer

Example 1: solving for buffer time required at 12 Kbytes(96,000 bits)per second

x=?

y=120 sec

z=12 Kbytes

w=2 Kbytes

m=10 fps

n=1.2 Kbytes

x=((10(2)−10(1.2))(120))/12

x=80 sec.

Ratio of content to advertising and sp at 12 Kbytes(96,000 bits)per second 2:3

x=?

y=120 sec

z=7 Kbytes

w=2 Kbytes

m=6 fps

n=1.2 Kbytes

X=((6(2)−6(1.2))(120)/7

X=82 sec

Ratio of content to advertising and sp at 7 Kbytes (56,000 bits) per second=2:3

Assumption 40 K upload speed of server network content delivery system

Intro and sp sequences 8 to 15 bitmaps, 25 to 30 k

Length of intro and sp 5, 15, and 30 sec

dvj or talking heads avg. 8 to 10 frames, 25 to 30 k

length of talk 15 or 22.5 or 30 seconds

Sec Down at 40 kps

5 200 k

15 600 k

22.5 900 k

1200 k

Use choosing or any period in which user has not actually asked for content utilize time to load commercials and tv non-avid programming 30 sec b/w commercial at 3 K (450×200p)=1,350= at 40 kps 33 sec

30 sec clr commercial at 4 k(450×200p)=1,800= at 40 kps 45 sec

33 secs at 40 kps six 5 sec pauses allow the download of commercial

45 sec at 40 kps nine 5 sec pauses allow 5 sec of black 200 k

Programmed content tv avg.

Programmed content mtv avg

2:30 dvj and commercial (w 6,000 k)

3:00 min showvideo

3:00 min video(at 2.5 kpf=6,750 k)

2:30 min commercial break and sp

3:00 min commercial and sp brk 0.44 k size inc. per frame

3:00 min video (at 2.5 kpf=6,750 k)

8:30 min show

2 videos (8 min) 0.44 k size inc. per frame

buf. sp/commercial: content 1:3.5

sp/commercial: content 3:8

sp/commercial: content 3:8

Phase 1b (JPEG based proprietary video software) Tests indicate 450×200 interlaced 15 fps video with avg frame size of 2.75-3.00 k possible Test 1 450×100 selblr 2891 180000 JPEG Quality=15 63:1 compression ratio

Utilize same modem maximization scheme adjust to produce size and quality increases

Phase 2a (modulation based proprietary software) 150:1 compression ratio

Utilize same modem maximization scheme adjust to produce size, speed and quality increases.

Digital character construction from set # of pre-cached frames

Description:

CAN (Compound Access Navigation)

Description:

Nav Stucture Phase 1

3 Main Buckets

10 Secondary Buckets

20 Category or Action Primary Selections

20 Category or Action Secondary Selections

20 Category or Action Tertiary Selections

20 Content selections

Total # of Accessible discreet items of content: 4.8 Million

Nav Structure Phase 2

5 Main Buckets

10 Secondary Buckets

20 Category or Action Primary Selections

20 Category or Action Secondary Selections

20 Category or Action Tertiary Selections

Also formulating an additive equation to describe the following frames might work as well (i.e. if the core image is moving across the picture area at a rate of 1 pixel per thirty frames the waves should have an xy motion coordinate and a delta value describing the change in the wave itself). Either system would radically reduce the transmission frame rate and transmission size for a given second of video and would imply some kind of time delay mechanism, (say 15 seconds), for the transmission versus viewing to check for error.

While the invention has been particularly shown and described with reference to a preferred embodiment hereof, it will be understood by those skilled in the art that several changes in form and detail may be made without departing from the spirit and scope of the invention.

What is claimed is:

1. A system and method for encoding and decoding an input video signal representative of a motion or still image, the input video signal being in either analog or digital form, the system comprising a first subsystem for encoding the input video signal into a data stream representative of the input video signal and transmitting the data stream over a transmission channel, a second subsystem for receiving and decoding the data stream using pre-cached and predetermined content to counteract channel data overflow, the method including the steps of capturing the signal from a video source, digitizing the signal into an encoded format, transmitting the encoded signal over a transmission channel, receiving the encoded signal, decoding the encoded signal, and displaying the decoded signal on a video display device.

2. The system and method of claim 1, wherein the transmission channel is a telephony channel.

3. The system and method of claim 1, wherein the transmission channel is an RF channel.

4. The system and method of claim 1, wherein the step of digitizing the signal into an encoded format includes using a partitive image encoding format.

5. The system and method of claim 1, wherein the transmission channel is a broadband digital transmission channel.

6. A method for encoding and decoding an input video signal representative of a motion or still image, the signal being in either analog or digital form, the system comprising: a first subsystem for encoding the signal into a data stream representative of the signal and transmitting the data stream over a communication channel, a second subsystem for receiving and decoding the data stream using pre-cached and predetermined content to counteract channel data overflow, the method including the steps of capturing the signal from a video source, digitizing the signal into an encoded format, transmitting the encoded signal over a transmission channel, receiving the encoded signal, and storing the encoded signal.

7. The method of claim 6, wherein the communication channel is a telephony channel.

8. The method of claim 6, wherein the communication channel is an RF channel.

9. The method of claim 6, wherein the step of storing the encoded signal comprises storing the signal in magnetic storage media.

10. The method of claim 6, wherein the communication channel is a broadband digital transmission channel.

11. A method for encoding a signal representing a video image, the method including the steps of:
a) deconstructing the signal into its component elementary parts;
b) quantizing the signal into a descriptive waveform according to a pre-determined luminance/chrominance field matrix of defined amplitude, the descriptive waveform being an optimally structured base code within the field matrix as defined by a minimum sampling rates needed to describe the video signal within an acceptable visible variation versus an acceptable bit-rate for the capacity of a transmission channel;
c) generating a lossless data compression base code, the code being dependent on the capacity limitations of the transmission channel or resultant code size;
d) transmitting the base code over the transmission channel;
e) receiving the base code;
f) decompressing the base code using the pre-determined luminance/chromainance field matrix and a pre-defined coding table; and
g) displaying the reconstructed image on a video display device.

12. The method of claim 11, wherein the transmission channel is a telephony channel.

13. The method of claim 11, wherein the transmission channel is an RF channel.

14. The method of claim 11, wherein the step of quantizing the signal into a descriptive waveform includes using a partitive image encoding format.

15. The method of claim 11, wherein the transmission channel is a broadband digital transmission channel.

16. A method for transmitting a video signal over a communication channel having a fixed bandwidth, the video signal including either motion or still images, the method comprising the steps of:
a) deconstructing the video signal into its component elementary parts;
b) quantizing the video signal into a descriptive waveform according to a pre-determined luminance/chrominance field matrix of defined amplitude, the descriptive waveform being an optimally structured base code within the field matrix according to a minimum sampling rates needed to describe the video signal within an acceptable visible variation vs. acceptable bit-rate for the capacity of the communication channel;
c) generating a lossless data compression base code, the code being dependent on the capacity limitations of the communication channel or the resultant code size;
d) transmitting the base code over the communication channel;
e) capturing the base code from the communication channel;
f) decompressing the base code using the pre-determined luminance/chromainance field matrix and a pre-defined coding table; and
g) displaying the reconstructed image on a video display device.

17. The method of claim 16, wherein the communication channel is a telephony channel.

18. The method of claim 16, wherein the communication channel is an RF channel.

19. The method of claim 16, wherein the step of quantizing the signal into a descriptive waveform includes using a partitive image encoding format.

20. The method of claim 16, wherein the communication channel is a broadband digital transmission channel.

21. A system for transmitting a video signal over a communication channel having a fixed bandwidth, the video signal including either motion or still images, the system comprising: an encoder for deconstructing the video signal into its component elementary parts, the encoder comprising a section for quantizing the video signal into a descriptive waveform according to a pre-determined luminance/chrominance field matrix of defined amplitude, the descriptive waveform being an optimally structured base code within the field matrix according to a minimum sampling rates needed to describe the video signal within an acceptable visible variation vs. acceptable bit-rate for the capacity of the communication channel; a section for generating a lossless data compression base code, the code being dependent on the capacity limitations of the communication channel or the resultant code size; a transmitter for transmitting the base code over the communication channel; a section for capturing the base code from the communication channel; and a decoder for reconstructing the base code by decompressing the base code using the pre-determined luminance/chrominance field matrix and a pre-defined coding table.

22. The system of claim 21, wherein the communication channel is a telephony channel.

23. The system of claim 21, wherein the communication channel is an RF channel.

24. The system of claim 21, wherein the step of quantizing the signal into a descriptive waveform includes using a partitive image encoding format.

25. The system of claim 21, wherein the communication channel is a broadband digital transmission channel.

26. A system and method for encoding and decoding an input video signal representative of a motion or still image, the input video signal being in either analog or digital form, the system comprising a first subsystem for encoding the input video signal into a partitive digital image description format data stream representative of the input video signal and transmitting the data stream over a transmission channel, a second subsystem for receiving and decoding the partitive digital image description format data stream using pre-cached and predetermined content to counteract channel data overflow, the method including the steps of capturing the signal from a video source, digitizing the signal into an encoded partitive digital image description format signal, transmitting the encoded signal over a transmission channel, receiving the encoded partitive digital image description format signal, decoding the encoded signal, and displaying the decoded signal on a video display device.

27. The system and method of claim 26, wherein the transmission channel is a telephony channel.

28. The system and method of claim 26, wherein the transmission channel is an RF channel.

29. The system and method of claim 26, wherein the transmission channel is a broadband digital transmission channel.

30. A method for encoding and decoding an input video signal representative of a motion or still image, the signal being in either analog or digital form, the system comprising: a first subsystem for encoding the signal into a partitive digital image description format data stream representative of the signal and transmitting the partitive digital image description format data stream over a communication channel, a second subsystem for receiving and decoding the partitive digital image description format data stream using pre-cached and predetermined content to counteract channel data overflow, the method including the steps of capturing an input video signal from a video source, digitizing the signal into a partitive digital image description encoded format, transmitting the encoded format over a transmission channel, receiving the encoded format, and storing the encoded format.

31. The method of claim 30, wherein the communication channel is a telephony channel.

32. The method of claim 30, wherein the communication channel is an RF channel.

33. The method of claim 30, wherein the step of storing the encoded signal comprises storing the signal in magnetic storage media.

34. The method of claim 30, wherein the communication channel is a broadband digital transmission channel.

35. A method for encoding a signal representing a video image, the method including the steps of:
a) deconstructing the signal into its component elementary parts;
b) quantizing the signal into a partitive digital image descriptive waveform according to a pre-determined luminance/chrominance field matrix of defined amplitude, the partitive digital image descriptive waveform being an optimally structured base code within the field matrix as defined by a minimum sampling rates needed to describe the video signal within an acceptable visible variation versus an acceptable bit-rate for the capacity of a transmission channel;
c) generating a lossless data compression base code, the code being dependent on the capacity limitations of the transmission channel or resultant code size;
d) transmitting the base code over the transmission channel;
e) receiving the base code;
f) decompressing the base code using the pre-determined luminance/chromainance field matrix and a pre-defined coding table; and
g) displaying the reconstructed image on a video display device.

36. The method of claim 35, wherein the transmission channel is a telephony channel.

37. The method of claim 35, wherein the transmission channel is an RF channel.

38. The method of claim 35, wherein the transmission channel is a broadband digital transmission channels.

39. A method for transmitting a video signal over a communication channel having a fixed bandwidth, the video signal including either motion or still images, the method comprising the steps of:
a) deconstructing the video signal into its component elementary parts;
b) quantizing the video signal into a partitive digital image descriptive waveform according to a pre-determined luminance/chrominance field matrix of defined amplitude, the partitive digital image descriptive waveform being an optimally structured base code within the field matrix according to a minimum sampling rates needed to describe the video signal within an acceptable visible variation vs. acceptable bit-rate for the capacity of the communication channel;
c) generating a lossless data compression base code, the code being dependent on the capacity limitations of the communication channel or the resultant code size;
d) transmitting the base code over the communication channel;
e) capturing the base code from the communication channel;
f) decompressing the base code using the pre-determined luminance/chromainance field matrix and a pre-defined coding table; and
g) displaying the reconstructed image on a video display device.

40. The method of claim 39, wherein the communication channel is a telephony channel.

41. The method of claim 39, wherein the communication channel is an RF channel.

42. The method of claim 39, wherein the communication channel is a broadband digital transmission channel.

43. A system for transmitting a video signal over a communication channel having a fixed bandwidth, the video signal including either motion or still images, the system comprising: an encoder for deconstructing the video signal into its component elementary parts, the encoder comprising a section for quantizing the video signal into a partitive digital image descriptive waveform according to a pre-determined luminance/chrominance field matrix of defined amplitude, the partitive digital image descriptive waveform being an optimally structured base code within the field matrix according to a minimum sampling rates needed to describe the video signal within an acceptable visible variation vs. acceptable bit-rate for the capacity of the communication channel; a section for generating a lossless data compression base code, the code being dependent on the capacity limitations of the communication channel or the resultant code size; a transmitter for transmitting the base code over the communication channel; a section for capturing the base code from the communication channel; and a decoder for reconstructing the base code by decompressing the base code using the pre-determined luminance/chrominance field matrix and a pre-defined coding table.

44. The system of claim 43, wherein the communication channel is a telephony channel wherein the communication channel is an RF channel.

46. The system of claim 43, wherein the communication channel is a broadband digital transmission channel.

47. A system and method for encoding and decoding an input video signal representative of a motion or still image, the input video signal being in either analog or digital form, the system comprising a first subsystem for encoding the input video signal into a non-partitive digital image description format data stream representative of the input video signal and transmitting the data stream over a transmission channel, a second subsystem for receiving and decoding the non-partitive digital image description format data stream using pre-cached and predetermined content to counteract channel data overflow, the method including the steps of capturing the signal from a video source, digitizing the signal into a non-partitive digital image description encoded format, transmitting the encoded signal over a transmission channel, receiving the encoded signal, decoding the encoded signal, and displaying the decoded signal on a video display device.

48. The system and method of claim 47, wherein the transmission channel is a telephony channel.

49. The system and method of claim 47, wherein the transmission channel is an RF channel.

50. The system and method of claim 47, wherein the transmission channel is a broadband digital transmission channel.

51. A method for encoding and decoding an input video signal representative of a motion or still image, the signal being in either analog or digital form, the system comprising: a first subsystem for encoding the input video signal into a non-partitive digital image description format data stream representative of the signal and transmitting the non-partitive digital image description format data stream over a communication channel, a second subsystem for receiving and decoding the non-partitive digital image description format data stream using pre-cached and predetermined content to counteract channel data overflow, the method including the steps of capturing an input video signal from a video source, digitizing the input video signal into a partitive digital image description encoded format, transmitting the encoded signal over a transmission channel, receiving the encoded signal, and storing the encoded signal.

52. The method of claim 51, wherein the communication channel is a telephony channel.

53. The method of claim 51, wherein the communication channel is an RF channel.

54. The method of claim 51, wherein the step of storing the encoded signal comprises storing the signal in magnetic storage media.

55. The method of claim 51, wherein the communication channel is a broadband digital transmission channel.

56. A method for encoding a signal representing a video image, the method including the steps of:
a) deconstructing the signal into its component elementary parts;
b) quantizing the signal into a non-partitive digital image descriptive waveform according to a pre-determined luminance/chrominance field matrix of defined amplitude, the non-partitive digital image descriptive waveform being an optimally structured base code within the field matrix as defined by a minimum sampling rates needed to describe the video signal within an acceptable visible variation versus an acceptable bit-rate for the capacity of a transmission channel;
c) generating a lossless data compression base code, the code being dependent on the capacity limitations of the transmission channel or resultant code size,
d) transmitting the base code over the transmission channel;
e) receiving the base code;
f) decompressing the base code using the pre-determined luminance/chromainance field matrix and a pre-defined coding table; and
g) displaying the reconstructed image on a video display device.

57. The method of claim 56, wherein the communication channel is a telephony channel.

58. The method of claim 56, wherein the communication channel is an RF channel.

59. The method of claim 56, wherein the step of storing the encoded signal comprises storing the signal in magnetic storage media.

60. The method of claim 56, wherein the transmission channel is a broadband digital transmission channels.

61. A method for transmitting a video signal over a communication channel having a fixed bandwidth, the video signal including either motion or still images, the method comprising the steps of:
a) deconstructing the video signal into its component elementary parts;
b) quantizing the video signal into a non-partitive digital image descriptive waveform according to a pre-determined luminance/chrominance field matrix of defined amplitude, the non-partitive digital image descriptive waveform being an optimally structured base code within the field matrix according to a minimum sampling rates needed to describe the video signal within an acceptable visible variation versus acceptable bit-rate for the capacity of the communication channel;
c) generating a lossless data compression base code, the code being dependent on the capacity limitations of the communication channel or the resultant code size;
d) transmitting the base code over the communication channel;
e) capturing the base code from the communication channel;
f) decompressing the base code using the pre-determined luminance/chromainance field matrix and a pre-defined coding table; and
g) displaying the reconstructed image on a video display device.

62. The method of claim 61, wherein the communication channel is a telephony channel.

63. The method of claim 61, wherein the communication channel is an RF channel.

64. The method of claim 61, wherein the communication channel is a broadband digital transmission channel.

65. A system for transmitting a video signal over a communication channel having a fixed bandwidth, the video signal including either motion or still images, the system comprising: An encoder for deconstructing the video signal into its component elementary parts, the encoder comprising a section for quantizing the video signal into a non-partitive digital image descriptive waveform according to a pre-determined luminance/chrominance field matrix of defined amplitude, the non-partitive digital image descriptive waveform being an optimally structured base code within the field matrix according to a minimum sampling rates needed to describe the video signal within an acceptable visible variation versus acceptable bit-rate for the capacity of the communication channel; a section for generating a lossless data compression base code, the code being dependent on the capacity limitations of the communication channel or the resultant code size; a transmitter for transmitting the base code over the communication channel; a section for capturing the base code from the communication channel; and a decoder for reconstructing the base code by decompressing the base code using the pre-determined luminance/chrominance field matrix and a pre-defined coding table.

66. The system of claim 65, wherein the communication channel is a telephony channel.

67. The system of claim 65, wherein the communication channel is an RF channel.

68. The system of claim 65, wherein the communication channel is a broadband digital transmission channel.
